(19) United States
(12) Patent Application Publication
(10) Pub. No.: US 2026/0162201 A1
(43) Pub. Date: Jun. 11, 2026

(54) AI-ASSISTED CHANGE OF ACADEMIC PATHWAY

(71) Applicant: Oracle International Corporation, Redwood Shores, CA (US)

(72) Inventors: James Thomas McKendree, Elizabeth, CO (US); Mayuko Ueda, Pleasanton, CA (US); Nicole Engelbert, New York, NY (US); Rakshita Kota, Redwood Shores, CA (US)

(73) Assignee: Oracle International Corporation, Redwood Shores, CA (US)

(21) Appl. No.: 19/179,899

(22) Filed: Apr. 15, 2025

Related U.S. Application Data
(60) Provisional application No. 63/691,244, filed on Sep. 5, 2024.

(51) Int. Cl. G06Q 50/20; G06Q 10/0631

(52) U.S. Cl. CPC G06Q 50/2053; G06Q 10/063112

(57) ABSTRACT

Systems, methods, and computer-readable media are provided to generate for a student different scores for different alternative academic pathways based at least in part on factors including differences in: conditions satisfied or not by the student for the academic pathways, course credit attained by the student for the different academic pathways, expected completion dates by the student for the different academic pathways, expenses predicted for the student for the different academic pathways, financial aid available to the student for the different academic pathways, skills and competencies matched for the student for the different academic pathways, and/or jobs compatible with the student for the different academic pathways. A particular alternative academic pathway may be selected by a student, initiating a change request that may be completed in a modifiable manner by a large language model using a prompt that informs the large language model of the factors for the student.

### CROSS REFERENCE TO RELATED APPLICATIONS

This application claims the benefit of U.S. Provisional Ser. No. 63/691,244, filed on Sep. 5, 2024. The entire disclosure of the aforementioned application is incorporated by reference herein in its entirety for all purposes.

### BACKGROUND

Accurate academic advice is helpful to students as they consider their options. Unfortunately, academic advisors focus often cannot provide more than high-level advice based on specific prior experiences. Actual changes in academic pathways may require approvals from various impacted entities and may cause changes that are not even visible to or accessible to the academic advisor. In light of the opaque nature of the student's private data, truly informative academic advice is not available in current systems.

Students making decisions on incomplete advice may experience unforeseen difficulties and be unable to complete their chosen academic pathway or delayed in completing their chosen academic pathway.

### BRIEF SUMMARY

In some embodiments, a computer-implemented method includes generating for a student different scores for different alternative academic pathways based at least in part on factors including differences in: conditions satisfied or not by the student for the academic pathways, course credit attained by the student for the different academic pathways, expected completion dates by the student for the different academic pathways, expenses predicted for the student for the different academic pathways, financial aid available to the student for the different academic pathways, skills and competencies matched for the student for the different academic pathways, and/or jobs compatible with the student for the different academic pathways. A particular alternative academic pathway may be selected by a student, initiating a change request that may be completed in a modifiable manner by a large language model using a prompt that informs the large language model of the factors for the student.

A computer-implemented method includes causing display of metadata for a current academic pathway of a user. The metadata comprises a measured performance on the current academic pathway, a first progress towards completing the current academic pathway, and a predicted completion date for the current academic pathway. For each remaining first required unit of academic progress on the current academic pathway, the computer-implemented method includes estimating a first cost to obtain the first required unit. Based on one or more first elective units remaining for the current academic pathway, the computer-implemented method includes estimating a second cost to obtain the one or more first elective units. The second cost is based at least in part on historical elective units taken for the current academic pathway. The computer-implemented method further includes causing display of a plurality of alternative academic pathways. Each alternative academic pathway of the plurality of alternative academic pathways is scored based at least in part on: determining a second progress towards completing the alternative academic pathway based at least in part on, for each unit of academic progress on the current academic pathway; determining whether the unit counts towards academic progress on the alternative academic pathway; and determining a net cost difference between the current academic pathway and the alternative academic pathway. Determining the net cost difference is based at least in part on, for each remaining second required unit of academic progress on the alternative academic pathway, estimating a third cost to obtain the second required unit. Based on one or more second elective units remaining for the alternative academic pathway, determining the net cost includes estimating a fourth cost to obtain the one or more second elective units. The fourth cost is based at least in part on historical elective units taken for the alternative academic pathway. Determining the net cost further includes determining a difference between aid available for the current academic pathway in comparison to the alternative academic pathway. The computer-implemented method further includes receiving a selection of a particular alternative academic pathway. The computer-implemented method further includes generating a prompt comprising a particular combination of the second progress towards completing the particular alternative academic pathway, and the net cost difference between the particular alternative academic pathway and the current academic pathway. The computer-implemented method further includes prompting a large language model using the prompt to generate one or more reasons for changing academic pathways to the particular alternative academic pathway. The computer-implemented method further includes causing display of the one or more reasons in an editable text window for submission in a process for changing academic pathways to the particular alternative academic pathway.

In a further embodiment, the computer-implemented method further includes determining an interest-based fit between one or more interests stored in association with the user's profile and one or more interests stored in association with the alternative academic pathway. The prompt further includes first information about the one or more interests stored in association with the users profile, second information about the one or more interests stored in association with the particular alternative academic pathway, and third information about one or more interests stored in association with the current academic pathway.

In the same or a different further embodiment, the computer-implemented method further includes determining a skill-based fit between one or more skills stored in association with the user's profile and one or more skills stored in association with the alternative academic pathway. The prompt further includes first information about the one or more skills stored in association with the users profile, second information about the one or more skills stored in association with the particular alternative academic pathway, and third information about one or more skills stored in association with the current academic pathway.

In the same or a different further embodiment, the computer-implemented method further includes generating a summary of the net cost difference based at least in part on prompting the large language model with another prompt that includes information about the third cost, the fourth cost, and the difference between aid available for the current academic pathway in comparison with the alternative academic pathway. The computer-implemented method further includes causing display of the summary in association with the net cost difference before receiving the selection of the particular alternative academic pathway.

In the same or a different further embodiment, the computer-implemented method further includes retrieving first information from a financial aid data source using one or more first authentication parameters, and retrieving second information from an expense data source using one or more second authentication parameters. At least part of the first information and at least part of the second information is included in the prompt. The one or more reasons account for the at least part of the first information and the at least part of the second information. In a further embodiment, the retrieving the first information is performed by a first agent with access to separate tools using separate authentication parameters than a second agent. The retrieving the second information is performed by a second agent with access to separate tools using separate authentication parameters than the first agent.

In the same or a different further embodiment, the computer-implemented method further includes retrieving financial information from a first source using one or more first authentication parameters, and retrieving course information from a second data source using one or more second authentication parameters. The prompt includes at least part of the first information and at least part of the second information. The one or more reasons account for the at least part of the first information and the at least part of the second information. In a further embodiment, the retrieving the first information is performed by a first agent with access to separate tools using separate authentication parameters than a second agent. The retrieving the second information is performed by a second agent with access to separate tools using separate authentication parameters than the first agent.

In the same or a different further embodiment, the computer-implemented method further includes retrieving credit information from a first source using one or more first authentication parameters, and retrieving course information from a second data source using one or more second authentication parameters. The prompt includes at least part of the first information and at least part of the second information. The one or more reasons account for the at least part of the first information and the at least part of the second information. In a further embodiment, the retrieving the first information is performed by a first agent with access to separate tools using separate authentication parameters than a second agent. The retrieving the second information is performed by a second agent with access to separate tools using separate authentication parameters than the first agent.

In some embodiments, a system is provided that includes one or more data processors and a non-transitory computer-readable storage medium containing instructions which, when executed on the one or more data processors, cause the one or more data processors to perform part or all of one or more methods disclosed herein.

In other embodiments, a computer-program product is provided that is tangibly embodied in a non-transitory machine-readable storage medium and that includes instructions configured to cause one or more data processors to perform part or all of one or more methods disclosed herein.

Cloud services, microservices, or other machine-hosted services may be offered that perform part or all of one or more methods disclosed herein. The machine-hosted services may be provided by a single machine, by a cluster of machines, or otherwise distributed across machines. The one or more machines may be configured to send and receive data, which may include instructions for performing the methods or results of performing the methods, via an application programming interface (API) or any other communication protocol.

In various embodiments, part or all of one or more methods disclosed herein may be performed by stored instructions such as a software application, computer program, or other software package installed in memory or other storage of a computing platform, such as an operating system, which provides access to physical or virtual computing resources. The operating system may provide access to physical or virtual resources of a mobile computing device, a laptop computing device, a desktop computing device, a server computing device, a container in a virtual machine on a computing device, or any other computing environment configured to execute stored instructions.

As used herein, the terms “first,” “second,” “third,” “fourth,” etc. are used as naming conventions to refer to separate items in a set of items. These naming conventions do not imply ordering unless such ordering is explicitly noted using language specific to ordering, such as “before” or “after,” or unless such ordering is required to attain the expressly recited functionality, such as generating an item and later accessing the generated item.

The techniques described above and below may be implemented in a number of ways and in a number of contexts. Several example implementations and contexts are provided with reference to the following figures, as described below in more detail. However, the following implementations and contexts are but a few of many.

### BRIEF DESCRIPTION OF THE DRAWINGS

Various embodiments are described hereinafter with reference to the figures. It should be noted that the figures are not drawn to scale and that the elements of similar structures or functions are represented by like reference numerals throughout the figures. It should also be noted that the figures are only intended to facilitate the description of the embodiments. They are not intended as an exhaustive description of the disclosure or as a limitation on the scope of the disclosure.

FIG. 1 illustrates a flow chart of an example process that generates for a student different scores for different alternative academic pathways based at least in part on various factors, and initiates a change request that may be completed in a modifiable manner by a large language model using a prompt that informs the large language model of the factors for the student.

FIG. 2 illustrates a system diagram showing an example academic planning system that generates for a student different scores for different alternative academic pathways based at least in part on various factors, and initiates a change request that may be completed in a modifiable manner by a large language model using a prompt that informs the large language model of the factors for the student.

FIG. 3 depicts an example user interface showing current grades for a student and an option to explore related academic pathways.

FIG. 4 depicts an example user interface showing alternative academic pathways and scores.

FIG. 5 depicts an example user interface showing drill-down information for a particular alternative academic pathway.

FIG. 6A-6E depict example user interface(s) showing various factors that may contribute to a score or other reason for changing to the particular alternative academic pathway or not.

FIGS. 7-12 depict example user interface(s) showing a change request with a reason that may be populated or revised using a large language model.

FIG. 13 depicts an example user interface showing that a change request is pending review.

FIG. 14 depicts an example user interface showing tasks for student review and recent activities including the submitted change request and its status.

FIG. 15 depicts a simplified diagram of a distributed system for implementing certain aspects.

FIG. 16 is a simplified block diagram of one or more components of a system environment by which services provided by one or more components of an embodiment system may be offered as cloud services, in accordance with certain aspects.

FIG. 17 illustrates an example computer system that may be used to implement certain aspects.

### DETAILED DESCRIPTION

A description is provided in the following sections for an academic planning system that generates for a student different scores for different alternative academic pathways based at least in part on various factors, and initiates a change request that may be completed in a modifiable manner by a large language model using a prompt that informs the large language model of the factors for the student. The sections include:
ACADEMIC PLANNING SYSTEM
ESTIMATING COST TO COMPLETE CURRENT AND ALTERNATIVE ACADEMIC PATHWAY
ESTIMATING A NET IMPACT OF CHANGING ACADEMIC PATHWAYS
GENERATING CHANGE REQUEST TEXT TO JUSTIFY CHANGING ACADEMIC PATHWAYS
INTERFACE AND LOGIC FOR APPROVING CHANGE REQUESTS
COMPUTER SYSTEM ARCHITECTURE

The steps described in individual sections may be started or completed in any order that supplies the information used as the steps are carried out. The functionality in separate sections may be started or completed in any order that supplies the information used as the functionality is carried out. Any step or item of functionality may be performed by a personal computer system, a cloud computer system, a local computer system, a remote computer system, a single computer system, a distributed computer system, or any other computer system that provides the processing, storage and connectivity resources used to carry out the step or item of functionality.

Changing majors represents a significant pain point for students, often times resulting in disastrous delays in time to graduation, reductions in financial aid eligibility, and even diminished early career outcomes. This is due to the lack of visibility when students select new programs and courses and the reliance on manual and error-prone approval processes. The AI-assisted change of major feature leverages a combination of classic and generative AI, as well as virtual assistant capabilities to empower students to engage in personalized scenario planning to understand the timeline, financial and career implications before selecting a new major, auto-approve changes within institutional standards and policies, summarize qualifications and make application to the new program when appropriate, and adopt or modify a recommended slate of new courses.

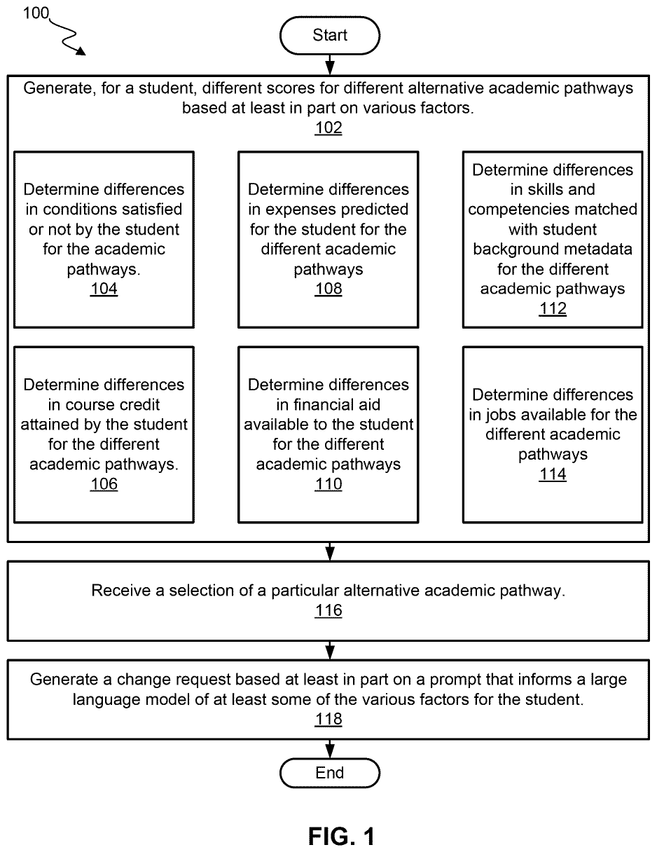

FIG. 1 illustrates a flow chart of an example process 100 where an academic planning system generates for a student different scores for different alternative academic pathways based at least in part on various factors, and initiates a change request that may be completed in a modifiable manner by a large language model using a prompt that informs the large language model of the factors for the student. As shown, block 102 includes generating for a student different scores for different alternative academic pathways based at least in part on various factors. Sub-block 104 includes determining differences in conditions satisfied or not by the student for the academic pathways. Sub-block 106 includes determining differences in course credit attained by the student for the different academic pathways. Sub-block 108 includes determining differences in expected completion dates by the student for the different academic pathways. Sub-block 110 includes determining differences in expenses predicted for the student for the different academic pathways. Sub-block 112 includes determining differences in financial aid available to the student for the different academic pathways, skills and competencies matched for the student for the different academic pathways. Sub-block 114 includes determining differences in jobs compatible with the student for the different academic pathways. In block 116, a selection is received of a particular alternative academic pathway. In block 118, the academic planning system generates a change request based at least in part on a prompt that informs a large language model of at least some of the various factors for the student.

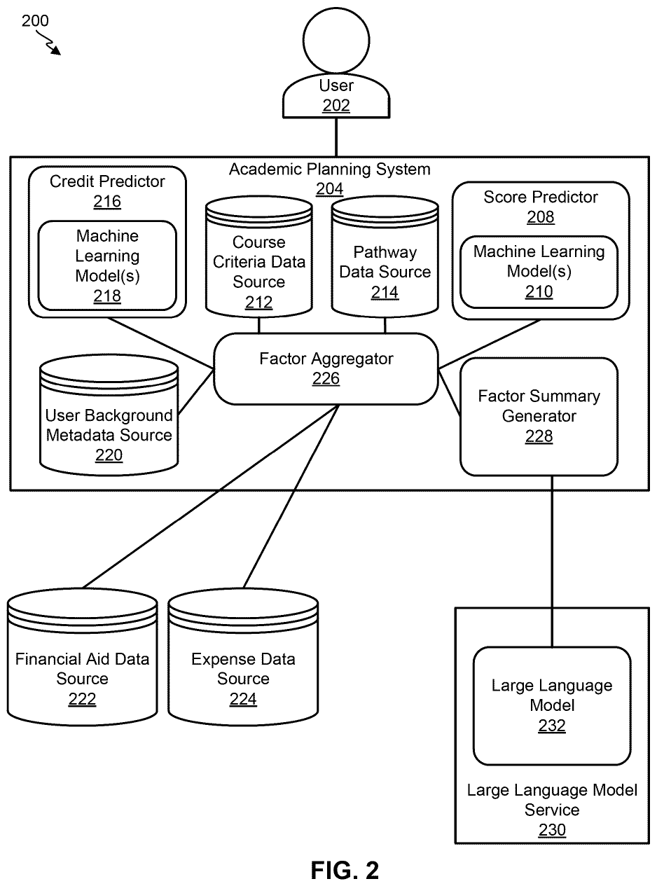

FIG. 2 illustrates a system diagram showing an example system 200 including an academic planning system 204 that generates for a student different scores for different alternative academic pathways based at least in part on various factors, and initiates a change request that may be completed in a modifiable manner by a large language model using a prompt that informs the large language model of the factors for the student. Academic planning system 204 includes factor aggregator 226, which aggregates factors from pathway data source 214 that includes data about different academic pathways, both current and historical for machine learning purposes. Factor aggregator 226 also aggregates factors from course criteria data source 212 that includes data about different courses, both current and historical for machine learning purposes. Credit predictor 216 predicts how many credits a student will need based on which existing credits count towards which different academic pathways, optionally based on machine learning model(s) 218 that predict credit transfers. The number of credits needed may be provided to factor aggregator 226. User background metadata source 220 may provide information about the user, interests, skills, and preferences to factor aggregator 226. Factor aggregator 226 may also pull in data about financial aid packages for the student from financial aid data source 222, and information about expenses expected for the student from expense data source 224. Those data sources may also employ machine learning model(s) (not shown) to predict an amount of financial aid that applies to different academic pathways and/or expenses for different academic pathways. Factor aggregator may provide aggregate data to score predictor 208, which uses machine learning model(s) 210 to predict scores for different academic pathways. Score predictor 208 may receive feedback from students based on change requests made or backup academic pathways selected to promote higher scores for historically selected academic pathways relevant to certain aggregate factors. Factor summary generator 228 may summarize one or more factors using large language model 232 of large language model service 230. Prompts to large language model 232 may include various aspects of aggregated factors from factor aggregator 226.

### Academic Planning System

Academic planning systems such as Oracle Fusion Cloud Student make the complex simple, freeing educators to shape the future of higher education, confident in their ability to deliver an exceptional student experience. Built on the world's leading cloud technology and shaped by 30 years of higher education expertise, Oracle Student (which is comprised of two core modules, Oracle Student Management and Oracle Student Financial Planning) is ready to light the academic spark for the next generation of students. Oracle Student Management, which covers admissions, academics, advising, financials, and core frameworks, helps students and staff work smarter—not just more efficiently, but more effectively—by anticipating students'needs, illuminating their academic path, and empowering them to succeed. Traditional and continuing education programs may be managed within one system. With Oracle Student Management, administrators can set up, track, and manage all academic information, regardless of academic structure or curriculum type—empowering institutions to support lifelong learning in a single application.

Example features of the academic planning system include:
Curriculum Registry: Manage variable course lengths, grade & credit types, and credentials.
Multiple assessment types: Define credentials such as a degree or certificate to a program of study.
Structured learning paths: Support individual learning journeys by defining unique requirements (e.g., minimum number of credits, minimum grade or result) for a major, a minor or a certificate program.
Academic calendars: Expand and define the time periods associated with learning activities, including the dates that students can enroll or drop courses and the dates when grades are due.
Student results: Define, track, and manage course results and program credentials earned by a student, regardless of educational model.
Pay-to-enroll: Manage billing and fees for pay-to-enroll programs and courses (e.g., for continuing education).
Sponsorships: Define third parties who sponsor learner activities; define the amount of the sponsorship and the eligible students and courses.
Delegate functionality: Enable delegate or proxy access to the student system to complete key transactions for a learner (e.g., their child) while maintaining FERPA compliance.
Real-time insights and integrated dashboards: Intervene and advise in real time to boost student retention, recruitment, and other success metrics.
Dynamic entities: Empower dynamic collaboration and restructure your institutional and academic programs and structures (e.g., institutional systems, consortia, multi-institution degrees and short-term exchange structures) without re-implementation.

In various examples, the academic planning system empowers institutional innovation and student agency with Student Management (admissions, academics, student financials, and core frameworks) and Student Financial Planning (financial aid).

In various examples, the academic planning system features:
Lifelong learning on a single platform
Touchless processes and smart alerts
Core frameworks futureproof your investment
Dynamic entities empower structural change

The student planning system may simplify the student experience. Student Management provides students with the tools and information for academic planning, while proactive alerts generated by intelligent automation help them make the right academic choices. Example student self-service capabilities include:
Student Central: Provides a streamlined, dynamic, and personalized landing page with widgets that display critical tasks and status information.
User Account/Profile: Create self-service account and manage personal information such as names, addresses, phone numbers, email, etc.
Search learning opportunities: Quickly and easily find the right class with modern search paradigms, from intelligent type-ahead searching to curated postings (such as trending or highlighted courses) to the use of configurable filters to narrow results.
Enroll and pay-to-enroll: Quickly find a course (including the number of open seats), add it to a shopping cart, and pay (for nontraditional programming).
Course Scheduler: Enroll in courses based on program requirements (for traditional programs).
My Finances: Gain full overview of the student's financial situation with direct access to their individual account: drill down into any transaction; view details such as total balance due, due dates, and payment history; pay bills by credit card or direct bank payment; manage refunds.
Academic Plan Template: Lay out courses and academic elements for a program of study into a logical sequence against a predetermined program structure (such as a 4-year regular undergraduate program).
Tasks and checklists: View and manage tasks and checklists.
Automated communications: Set emails and other alerts to be automatically triggered to students based on certain dates, actions, or events (e.g., confirmation of enrollment).

Student Central provides students with an intuitive, personalized experience.

The academic planning system manages student billing with a modern payments ecosystem Built on Oracle's leading ERP solution, Oracle Student Management enhances institutions'ability to manage student receivables, billing, and payment collection, from pay-to-enroll courses to matriculated tuition to corporate invoices.

Example financials capabilities include:
My Finances: Drill down into any transaction, view details such as total balance due, due dates, and payment history, and pay bills by credit card or direct bank payment. A manual payment option allows students to pay fees in person or over the phone.
Student accounts and invoicing: Create charges, accept payments, process refunds, and generate receipts.
Personalize the experience to the student or administrator
Inform the student or administrator where they are in any process
Automate tasks that do not require a decision or that historically resolve consistently in a certain way under similar circumstances
Remove the noise by only showing what the student or administrator need to do
Prevent student or administrator mistakes in real-time
Deliver insights, when the student or administrator needs it, to make decisions easier
Access on any device, anytime
A consistent application experience, regardless of device
Settings should be in context with what the student or administrator is doing
Bills: View all generated bills and download or print the files in .pdf format.
Tuition and fees assessment: Dynamically and accurately assess a variety of tuition and other fees associated with student enrollment. Population selection criteria enables institutions to select and assess fees or discounts for individuals or groups of students.
Sponsorship agreements: Manage sponsorship agreements (an arrangement between an institution and a third party or sponsor that enables the external organization to pay some or all of the charges that appear on a student's bill). Institutions can assign a sponsorship credit to a sponsorship agreement to simplify student bill-paying.
Invoices: Identify billing transactions and create invoices for students and organizations, using the billing criteria you provide, such as date of transaction or payment schedule due date.
Learning Packages: Support payments of a one-time flat fee attached to a program (e.g., a learning package). After paying the fee, students can access and enroll in courses affiliated with the program.

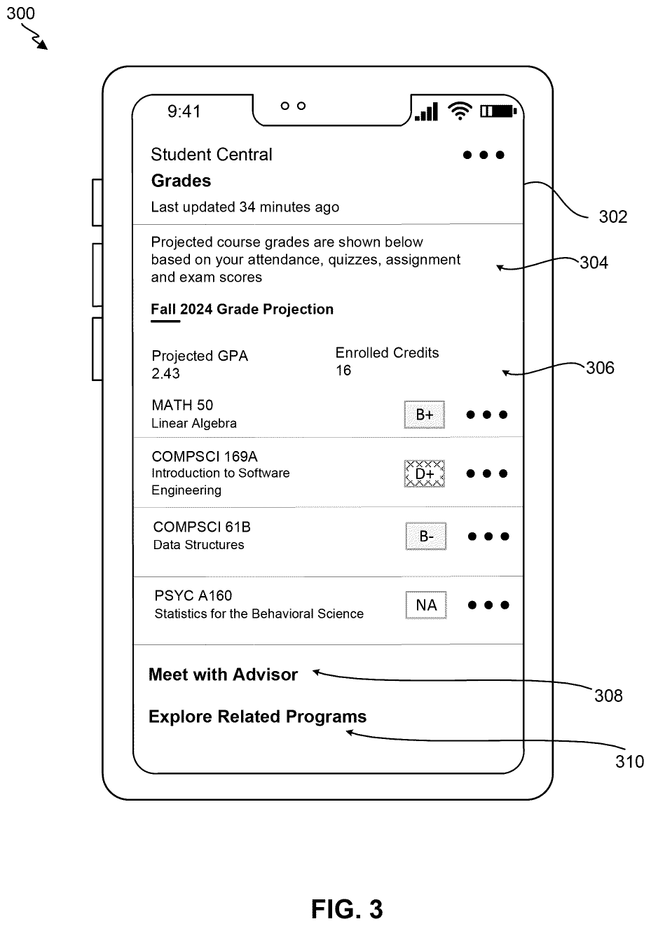

The academic planning system may offer a practical path to a unified higher education cloud. FIG. 3 shows an example user interface 302 displayed on an academic planning client device 300 and provided by the academic planning system to review academic performance. Interface 302 includes a summary of course grade content 304 as well as individualized course grade projections 306. Interface 300 may include an option 308 to meet with an advisor, which, when selected, causes a scheduling tool to find a mutually available time on a private calendar of the advisor and a private calendar of the student. The scheduling tool may have access to both private calendars and/or to public portions of the private calendars in order to propose a mutually agreeable time. As shown in FIG. 3, an option 310 may be displayed, optionally on swiping up from the bottom of the screen or otherwise in from a side, top, or bottom of the screen, and/or hovering at an edge of the screen. The option 310 may include exploring related programs.

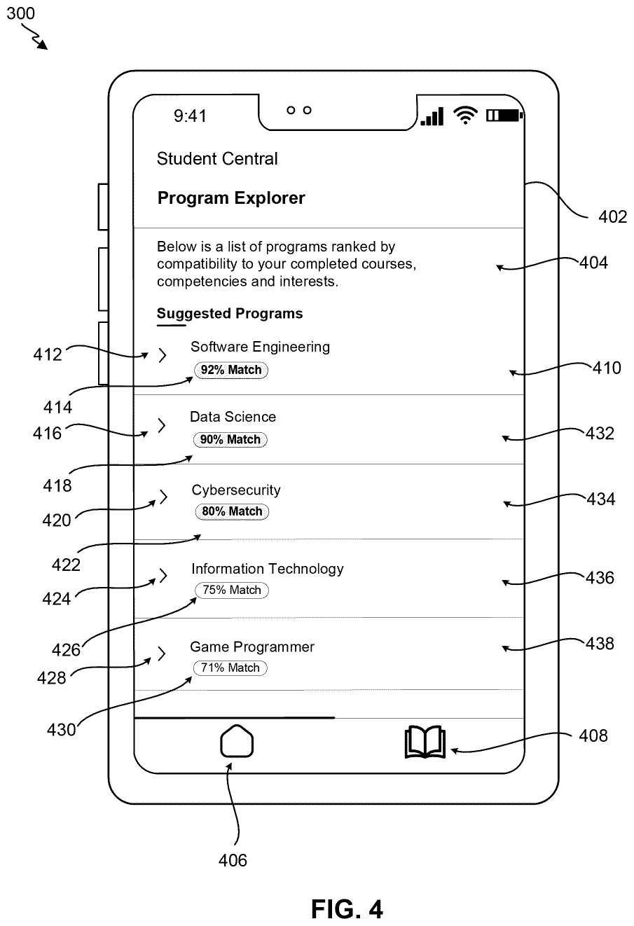

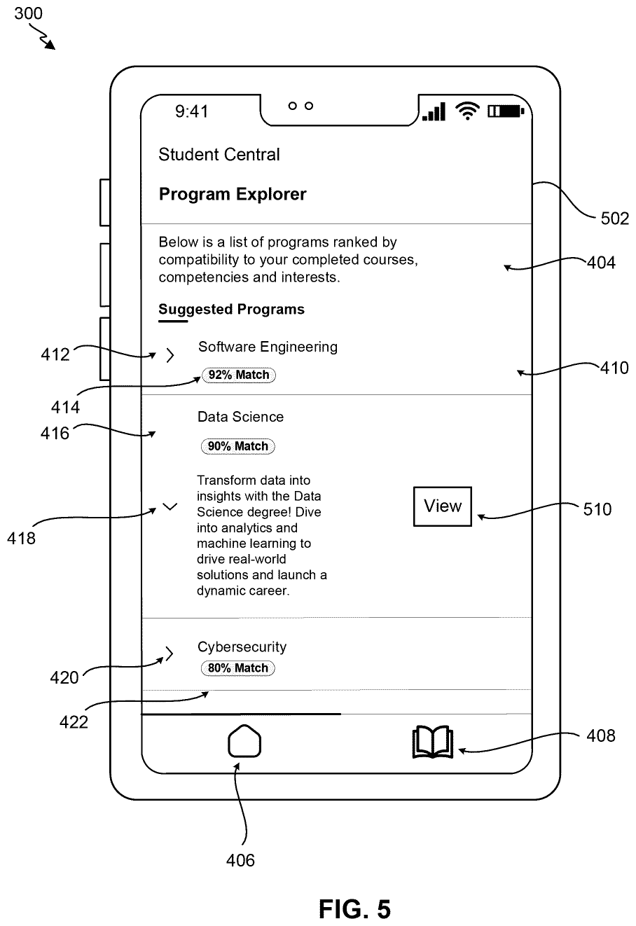

Upon selection of the option, the user interface 302 may navigate to a Program Explorer screen 402 with a summary of program explorer content 404 and suggested alternative academic pathways or programs 410 ranked by compatibility to the student, as shown in FIG. 4. Additional details may be shown for individual options 410, 432, 434, 436, and 438 selected or selectable in the Program Explorer, and an option to drill down further into the academic pathway, for example, using a “View” button 510, shown in FIG. 5, or by selecting the suggested program 410, 432, 434, 436, or 438 or the corresponding expand arrow 412, 416, 420, 424, or 428, as shown by selected expand arrow 418 in FIG. 5. A match score 414, 418, 422, 426, and 430 may be determined for each program option 410, 432, 434, 436, and 438.

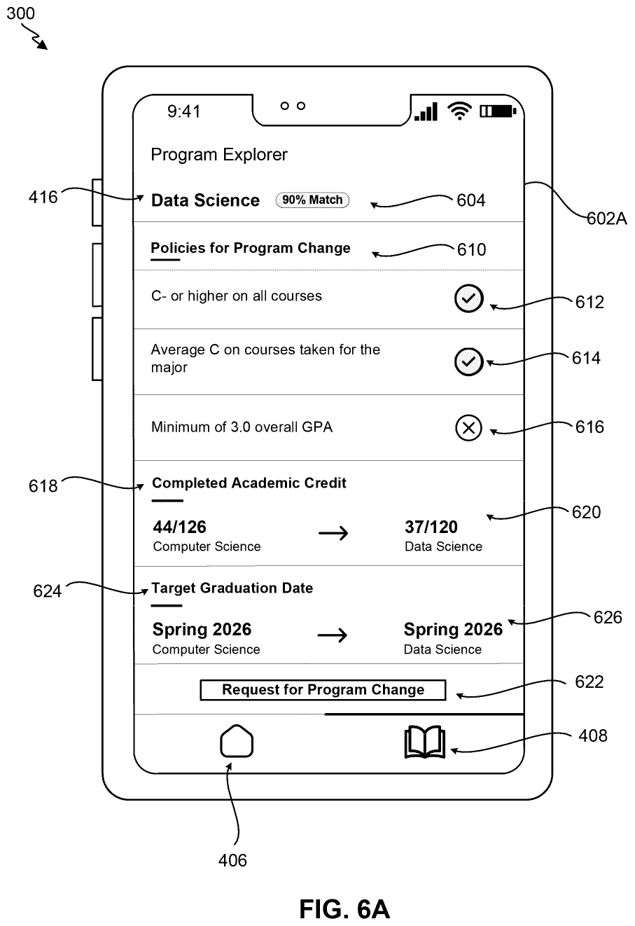

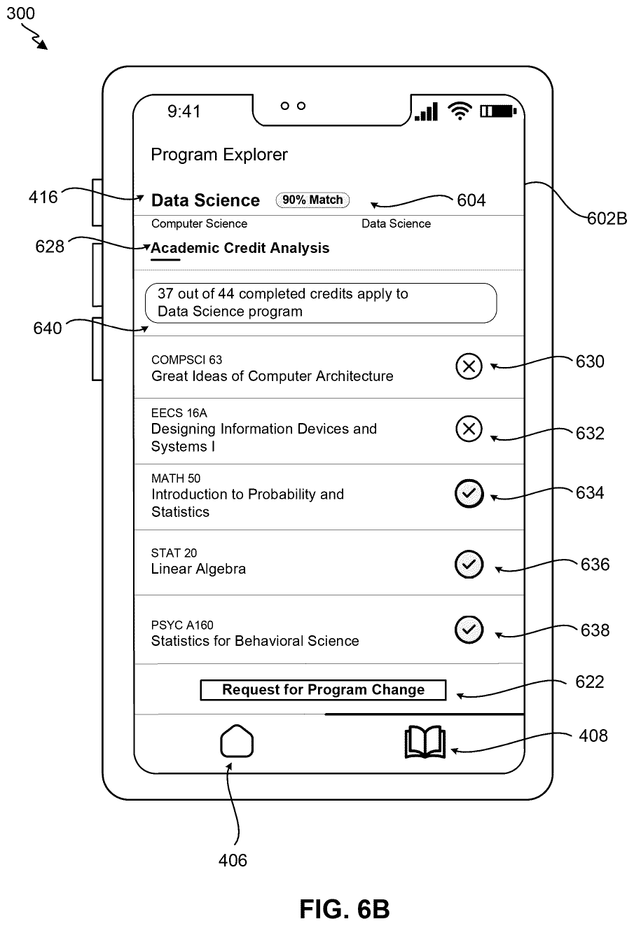

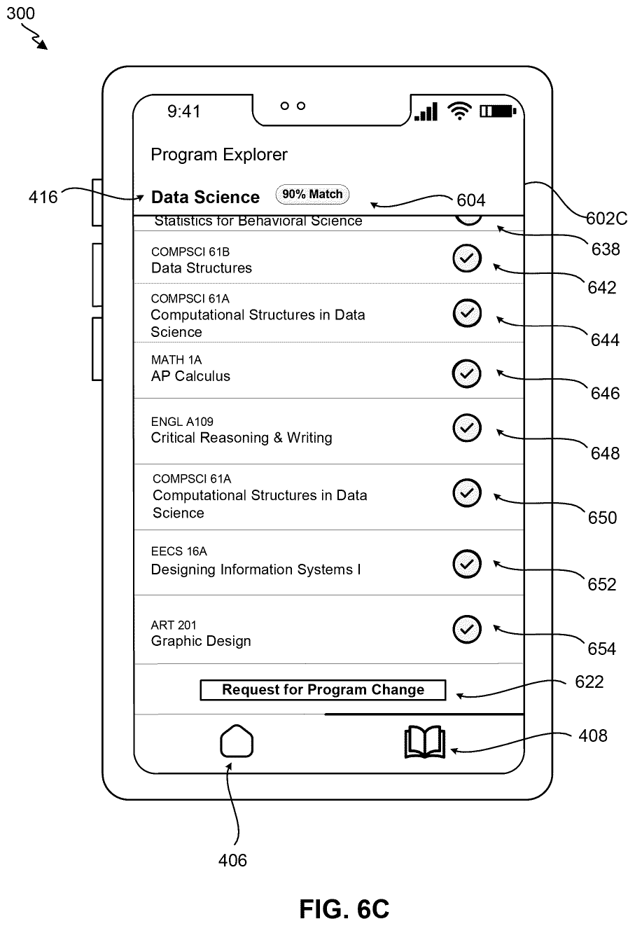

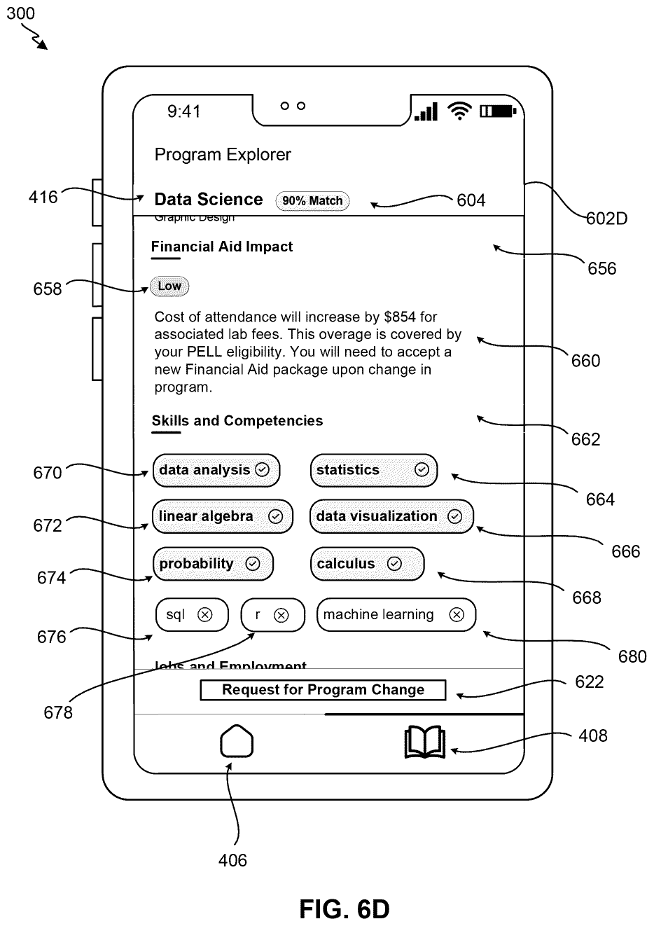

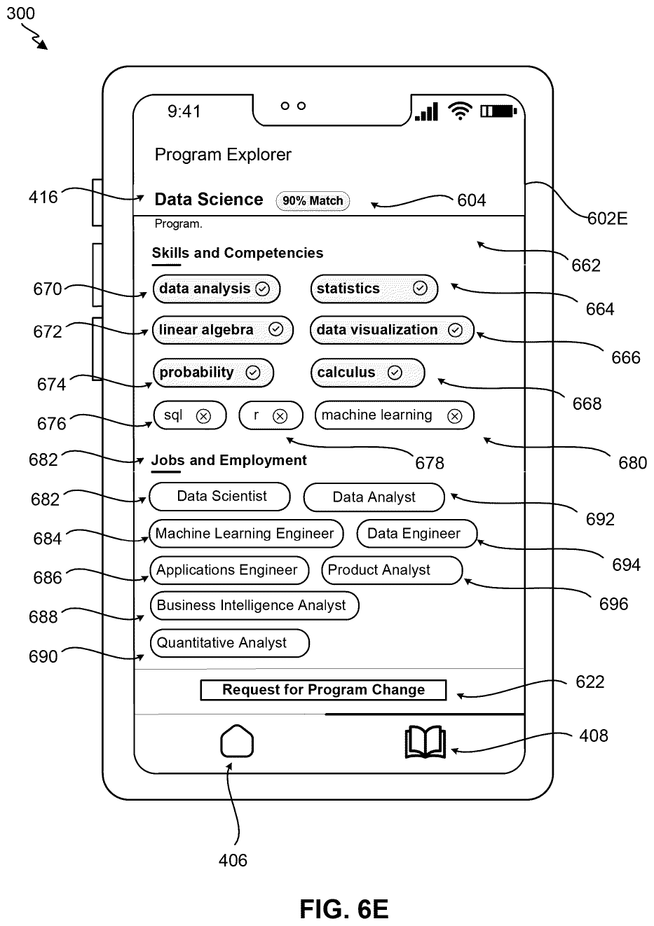

Upon selection of the drill-down option 510, the Program Explorer may provide individual analytics for the selected academic pathway 416 indicating various factors that are considered to score the academic pathway 416 and/or otherwise to provide guidance on a match of the academic pathway 416 to the student as indicated by match score 604. The individual analytics are shown in interfaces 602A-602E of FIGS. 6A-6E.

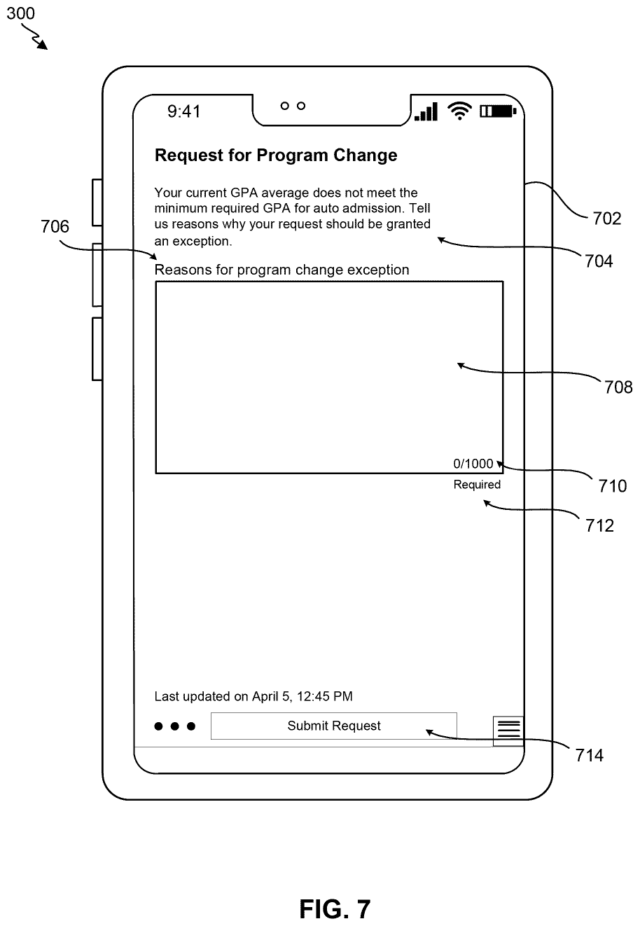

Upon a selection to change an academic pathway to a target academic pathway, for example, using option 622, an interface 702 may be displayed to supply a reason for a program change 706 and/or any other requested information of the student, as shown in FIGS. 7-12, where reasons may be assisted using generative artificial intelligence that is provided with access to characteristics that contributed to the student's score for the academic pathway. The request for program change may include a summary 704 of why an exception is needed and/or why the policies do not otherwise allow an automatic change. Field 706 may accept the reason for program change exception in region 708, subject to limit(s) 710 that may be placed on the reason such as character length limits. Certain field(s) may be required, as indicated by marker 712, and other field(s) (not shown in the example) may also be required or may be optional. The request may be submitted using option 714, triggering an approvals process that may be specific to the source program, the target program, or any other stored logic for obtaining approvals for a request having characteristics similar to the request initiated in FIGS. 7-12.

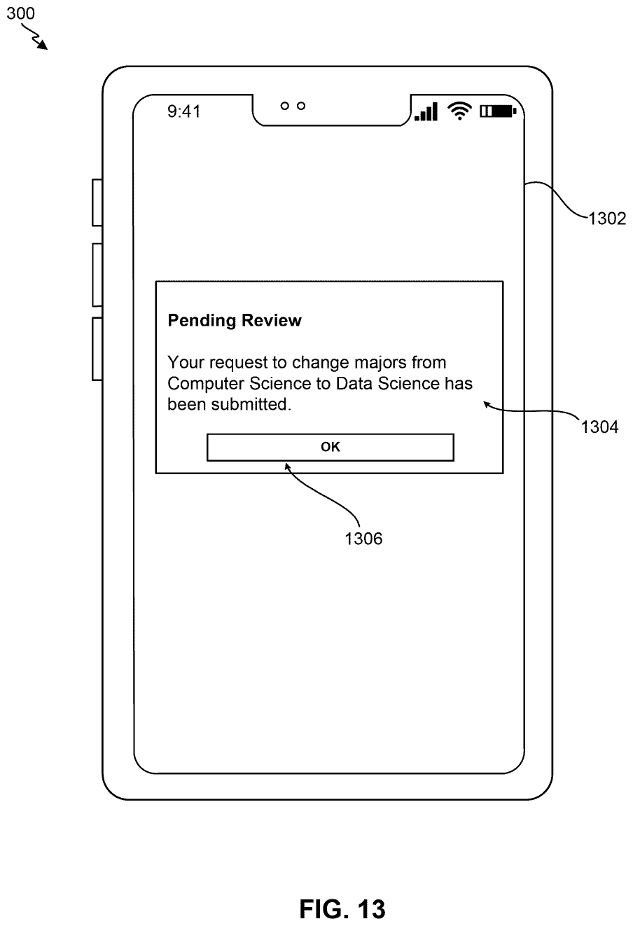

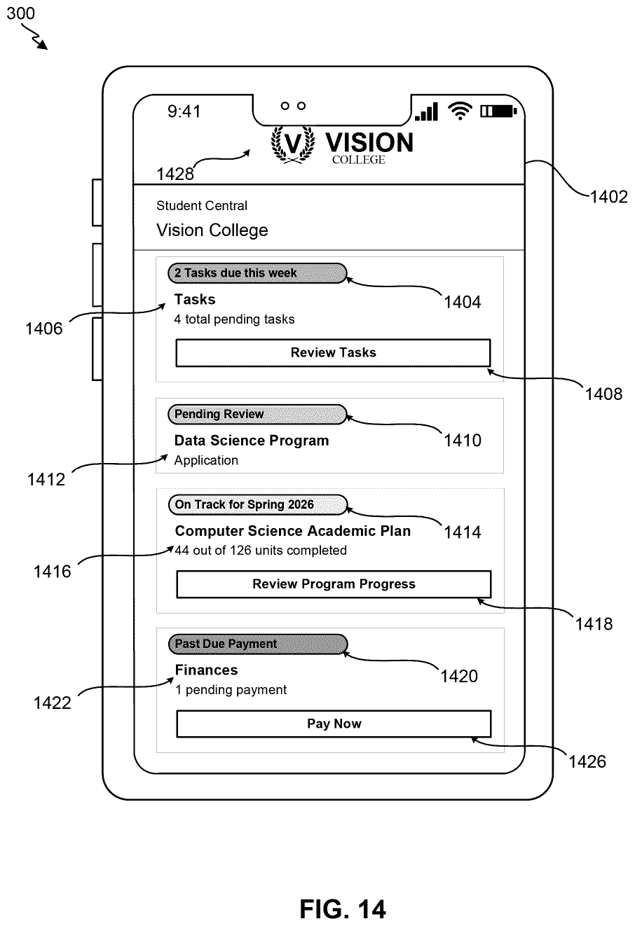

Upon submission of the reasons, the user may be presented with a confirmation screen 1302 with a notification 1304 indicating that the change request is pending review by an administrator, as shown in FIG. 13. An option 1306 to confirm the notification 1304 may also be displayed. Then, as shown in FIG. 14, the change request pending review, indicated by status marker 1410, may show up as item 1412 on a user task bar that also shows, for example, current academic progress (indicated by item 1416 and status marker 1414), finance-related activities (indicated by item 1422 and status marker 1420), and other tasks needing attention (indicated by item 1406 and status marker 1404). Interface 1402 may also include option 1408 to review pending tasks, option 1418 to review program progress, and/or option 1426 to make a payment. Interface 1402 may also include a header with a customized logo 1428 specific to the program and/or academic institution to which the student is currently enrolled.

### Estimating Cost to Complete Current and Alternative Academic Pathway

Analytics may be provided for a current academic pathway and/or alternative academic pathways. Alternative academic pathways may be selected as those that have a highest match with the student and/or those that the student has already identified as backup academic pathways, for example, via a user profile or configuration setting. The alternative academic pathways may be ranked based on a closeness of match to the student, and displayed with options to drill into particular alternative academic pathways, as shown in the example of FIGS. 4-5.

In various scenarios, an academic planning system analyzes existing courses that have been taken by a student pursuant to a current academic pathway. The academic planning system may predict which courses are likely to count towards a new academic pathway based at least in part on which courses have previously counted towards academic pathways other than the current academic pathway. Such predictions may be based on equivalency mappings between courses in different departments as well as machine learning applied to historical courses counting for different majors. For example, if a course has been used to fulfill a requirement of a target academic pathway in the past for another student, the course may be suggested as a possible avenue for fulfilling a requirement of the target academic pathway or a similar academic pathway in association with the student using the academic planning system.

FIG. 6A shows a policy section 610 showing policies 612, 614, and 616 for determining whether a program change is possible. In the example of FIG. 6A, policies for program change 612, 614, and 616 may be shown in association with a selected alternative academic pathway 416 such as Data Science. The policies 612, 614, and 616 indicate one or more conditions that should be satisfied, unless an exception is granted to override the policy, in order to change to the alternative academic pathway. Checkmarks or another graphic indicate conditions that are satisfied by the user, and an X or a different graphic indicates a condition that is not satisfied by the user. As shown, policies 612 and 614 are satisfied, but policy 616 (“Minimum of 3.0 overall GPA”) is not satisfied. Whether or not an exception is needed in order to choose the academic pathway may contribute to an overall score for the academic pathway in comparison with other academic pathways.

As shown in FIG. 6A, a completed academic credits section may show completed academic credits 620 are determined for a current academic pathway of computer science and an alternative academic pathway of data science. Although 37 of the credits carry over, the interface 602A shows that 4 of the credits do not carry over. The degree requires 6 fewer credits overall, resulting in a net decrease of 2 credits required to complete the alternative academic pathway. Interface 602A also shows a target graduation date section 624, which shows target graduation date information 626 indicating that the graduation date would be unimpacted in this example as a result of the example change. In other examples, the target graduation date may change. An option 622 may be selected to proceed to request to change the program to data science, which may cause display of an interface for request data submission and trigger downstream approval(s) upon submission. Home button 406 may return to an academic overview such as in FIG. 3 or a landing page such as in FIG. 14, and listing button 408 may return to a listing overview or program explorer view such as in FIG. 4 or a course listing view such as in FIG. 3.

FIG. 6B shows a summary 640 of the Academic Credit analysis, indicating that 37 out of 44 completed credits apply to the target academic pathway. A line-item summary of the completed credits that are predicted to apply or not to apply to the target academic pathway for line items 630, 632, 634, 636, and 638 are shown, with checkmarks or another graphic indicating the completed credits that apply and X's or another graphic indicating the completed credits that do not apply. As shown, credits for items 634, 636, and 638 are predicted to apply after the change, but credits for items 630 and 632 are predicted to not apply after the change. The line-item summary continues in FIG. 6C with items 642, 644, 648, 650, 652, and 654.

Applying the equivalency mappings and/or machine learning to immediately determine whether a course is likely to transfer may save a significant amount of time and expense for the student. For example, students may have to wait 9 months in some circumstances to receive a final clearance on whether courses will transfer or not to the new academic pathway, and the academic planning system can improve the visibility and efficiency of this process by transparently providing course transfer probability details to both the student using the academic planning system to make the change in academic pathway as well as the administrator(s) responsible for determining if the course work of the student is approved to transfer to the new academic pathway. Knowing that a course has counted for an academic pathway requirement “almost never” as compared to “almost always” for other students helps both the student and the administrator responsible for making a final decision.

In this manner, the administrator(s) responsible for determining if the course work of students is approved for transfer to meet requirements of a new academic pathway may be tasked with only reviewing those pairings of course work and requirements that are not almost always met based on historical data, clearing time for careful consideration of whether new precedents or exceptions should be set or made for new pairings of course work and requirements.

After determining which courses count towards a current and/or alternative academic pathway(s), a remaining time to complete the current and/or alternative academic pathway(s) may be determined based on which courses still need to be taken, when those courses are offered, course prerequisites, and how many hours or units are expected to be taken per term for the student. For example, different pathways may have different amounts of time expected to be taken for completion based on different numbers of remaining courses, different prerequisites, and different schedules of the different courses during the remaining time on the corresponding academic pathway.

In one embodiment, based on how long an academic pathway is expected to take for completion, the academic planning system may predict a cost of pursuing the academic pathway. For example, the cost may be based on a number of hours or units remaining to be taken, an expected cost of materials or facility fees (e.g., lab fees) for the courses to be taken, and a total amount of time or number of terms the student will remain enrolled and consuming housing, meal plans, and other resources.

In one embodiment, an academic planning system integrates with a course metadata platform to predict expenses corresponding to selected coursework that is probable for the current academic pathway and/or for alternative academic pathways. For example, facilities expenses, textbook or material expenses, lab expenses, travel expenses, housing expenses, and other expenses may be associated with different courses or different academic pathways. These expenses affect the match of the target academic pathway with the student, with higher expenses reflecting a poorer match and lower expenses reflecting a better match.

In one embodiment, a difference in expected travel or housing expenses is determined between different academic pathways corresponding to different facilities in different locations. The differences in travel or housing may account for either travel expenses from a student's current location or a cost of relocation and/or change in housing expenses and/or commute expenses at a new location. Different campuses for different academic pathways may be in different regions with different expected living expenses or different expected housing expenses, and these living expenses and/or housing expenses may also be included in the expected expenses.

In one embodiment, an academic planning system integrates with a financial institution associated with the student to account for an amount of cash on hand or allocated for academic pathways. A student with more cash allocated to academic pathways may be less impacted by increased expenses, and a student with less cash allocated to academic pathways may be more impacted by increased expenses. A higher impacted student may have a lower score for the target academic pathway, and a lower impacted student may have a higher score for the target academic pathway.

Additionally or alternatively, the academic planning system integrates with a financial platform to predict financial aid that is expected for a current academic pathway and/or for alternative academic pathways. For example, the financial aid platform may provide information indicating that the financial aid is dependent on one or more conditions, such as major, degree, field, hours enrolled (e.g., full-time versus part-time student), or completion date (e.g., limited to 4 years of financial aid). The academic planning system may predict, based on the one or more conditions, how much financial aid is likely to be provided for the different academic pathways and include these predictions in the overall cost.

In one embodiment, financial aid coverage may be determined based on a set of available academic pathways associated with a financial aid package, as well as different condition(s) for obtaining financial aid coverage for the different academic pathways. In another embodiment, in the absence of relevant stored information, the academic planning system generates a prompt to a large language model that includes a financial aid contract along with a question of whether the target academic pathway would be covered according to the financial aid contract. The large language model may be instructed to provide an answer with a corresponding confidence level, as well as underlying reasons for the answer that could be drilled into by the user via the user interface. The answer and confidence level may be used by the academic planning system determine whether the financial aid package is counted as covering or not the target academic pathway.

In one embodiment, a tuition calculation engine determines a tuition for an academic pathway based on the coursework and additional fees associated with the academic pathway. The tuition calculation engine determines different tuition calculations for different academic pathways to quantify differences in cost of attendance between the different academic pathways. The tuition calculation engine then generates a draft packaging and projection of aid eligibility for the student and returns a change in aid between the different academic pathways. The change in expenses and change in aid may be aggregated to determine an overall financial impact.

Differences in expenses or financial aid may be aggregated as a financial impact of a change from the current academic pathway to the alternative academic pathway for each alternative academic pathway shown.

In one embodiment, generative artificial intelligence is used to summarize aggregate financial impact including, for example, changes in expenses and financial aid corresponding to a target academic pathway. As shown in interface 602D of FIG. 6D, a financial aid impact may be scored with a score 658 as “High,” “Medium,” or “Low,” indicating how much added expense or removed financial aid or removed expense may be associated with the target academic pathway as compared to other available academic pathways, with the ratings corresponding to different thresholds of absolute and/or relative added expense or removed aid. An example summary 660 generated is shown in FIG. 6D, which states: “Cost of attendance will increase by $854 for associated lab fees. This average cost is covered by your PELL eligibility. You will need to accept a new Financial Aid package upon change in program.” The summary may be generated using a custom prompt to a large language model that includes factors such as expenses and financial aid packages that affect the financial aid impact, as well as a request for the large language model to explain or summarize the overall impact. The prompt may also specify length constraints on the response, and the response may be shown as summary 660.

Skills and competencies may also contribute to the score for whether the target academic pathway is a good match with the student or not. Skills or competencies needed or rewarded by the target academic pathway may match skills or competencies detected in the user's profile, badges, certifications, resume, course work listings, or work experience log (collectively, student background metadata). The student background metadata may be converted into a content vector embedding that represents detected features, skills, or competencies in the student background data. Similarly, courses and academic pathways may be converted into content vector embeddings that represent detected features, skills, or competencies that are useful for the academic pathway. A similarity between the vector embeddings may be determined, for example, based on Euclidean or cosine distance. The closer the match between the student background metadata and the skills or competencies of the academic pathway, the better the score for the academic pathway.

As shown in interfaces 602D and 602E of FIGS. 6D and 6E, skills and competencies are listed in skills and competencies section 662 as data analysis 670, statistics 664, linear algebra 672, data visualization 666, probability 674, and calculus 668, which were matched in both the target academic pathway and the student background metadata. These matches are visualized on the program explorer interface. Other relevant skills and competencies, such as sql 676, r 678, and machine learning 680 may be useful for the target academic pathway but unmatched by the student background metadata. These missing skills and competencies are also shown, graphically distinguished from the matching skills and competencies, for example, by shading, coloring, and/or graphical icons.

Jobs and employment useful for or relevant to the target academic pathway may also contribute to an overall score for how well the target academic pathway matches the student. Student background metadata matching job and employment categories for the target academic pathway may be detected. For example, job titles, fields, and/or corresponding job descriptions, which may be generated using generative artificial intelligence based on the job title, may be detected for students who completed or excelled in the target academic pathway. Vector embeddings may be created for the job titles, fields, and/or corresponding job descriptions may be compared to the vector embedding for the student background metadata to determine whether or not there is a match, and matched jobs and employment may be shown on the program explorer interface. More matches and stronger matches contribute to a higher overall match between the student and the target academic pathway. In the example interface 602E shown in FIG. 6E, no jobs or employment were matching between the student background metadata and the target academic pathway, leading to a lower overall score for the target academic pathway than had there been a match. If matches were present, they would be graphically distinguished from the non-matches shown in FIG. 6E, for example, by shading, coloring, and/or graphical icons. Unmatched jobs and employment items are shown as items 682, 684, 686, 688, 690, 692, 694, and 696 in the example.

### Estimating a Net Impact of Changing Academic Pathways

In one embodiment, in addition to determining an aggregate financial impact of changing academic pathways (with a high negative impact indicating a low match, a low negative impact indicating a higher match, a low positive impact indicating an even higher match, and a high positive impact indicating a highest match), the academic planning system may determine a predicted career impact or future earnings impact of changing academic pathways. For example, the predicted career impact or future earnings impact may indicate that a change will increase or decrease the probability of pursuing a certain career with higher or lower earnings. The probability determinations between careers and academic pathways may be based on a machine learning model that learns job details based on academic pathways, for example, based on user profiles, social media profiles of former students (e.g., LinkedIn), jobs placed upon completing the academic pathway, etc., and the probability of attaining jobs having certain details after pursuing certain academic pathways.

In various embodiments, the academic planning system generates a score for each academic pathway of a plurality of alternative academic pathways based on the net impact (e.g., financial impact) of the academic pathway, course credit that will carry over to the academic pathway, qualifications needed to pursue the academic pathway, skills or competencies exhibited (e.g., determined from a user profile, badges, certifications, resume, course work listing, or work experience log) associated with the academic pathway, and/or interests (e.g., determined from a user profile, resume, course work listing, or work experience log) associated with the academic pathway. Competencies indicate what a student has learned from prior course work (skills or competencies listed in association with the prior coursework, optionally only those for which the student exceeded threshold grade expectations), work experience, or other sources. Interests indicate what students have expressed interests in, as indicated from student activities, topics of completed courses, or self-expressed interests.

For example, common topics among courses taken and/or for which the student exceeded threshold grade expectations may be detected, as well as topics common to jobs held for the longest time or most recently, and these topics may be labeled as interests that academic pathways may match up well against or not depending on the topics most closely associated with the academic pathways and students who have completed or excelled in the academic pathways. For example, a cosine distance may be determine between vector embeddings for the academic pathway and vector embeddings for the topics detected for the user, and the academic pathway with the closest distance to the topics (interests, competencies, experience, coursework, etc.) associated with the user may receive the highest score. The best matching academic pathways may receive higher scores, and the worst matching academic pathways may receive lower scores.

In an example shown in FIG. 4, suggested alternative programs or academic pathways are shown with scores that are colored based on how well the academic pathway matches the user. As shown in FIG. 5, example academic pathways may be drilled into on the user interface to see lower-level details about each academic pathway.

In one embodiment, the academic planning system determines what experience, skills, and/or interests are present in user profiles, resumes, course work listings, or work experience logs for students who completed certain degrees, and what aspects of similar experiences, skills, and/or interests are present in user profiles, resumes, course work listings, or work experience logs of the user using the academic planning system. Vector embeddings may be generated from the various sources to represent the experiences, skills, and/or interests of students historically successful in certain academic pathways, and those vector embeddings may be compared to the student using the academic planning system to determine which vector embeddings are closest to the student using the academic planning system, for example, based on cosine similarity between the vector embeddings. The academic pathways that were chosen by the most similar profiles may be suggested as candidate academic pathways for the student using the academic planning system, optionally weighed based on how similar the student user's profile is to the historical profiles for that academic pathway.

The alternative academic pathways may be ordered or arranged based on score, and a most significant contributing factor to the score may be displayed in association with summary information (e.g., major name, degree name, or field) associated with the academic pathway.

In various embodiments, different factors may be weighted differently for different users as configured using a configuration interface specific to the student. The configuration interface may specify, for example, how cost conscious a student is, how much importance a student places on pursuing interests, skills, or experiences, an importance of a certain career or field, an importance of future salary or earning capacity, and/or how important it is for the student to maintain an expected graduation date without delay. The configuration interface may include sliding scales and/or absolute limits (in terms of expense and/or graduation date) that can be set by the user to be able to see recommendations within the limits.

### Generating Change Request Text to Justify Changing Academic Pathways

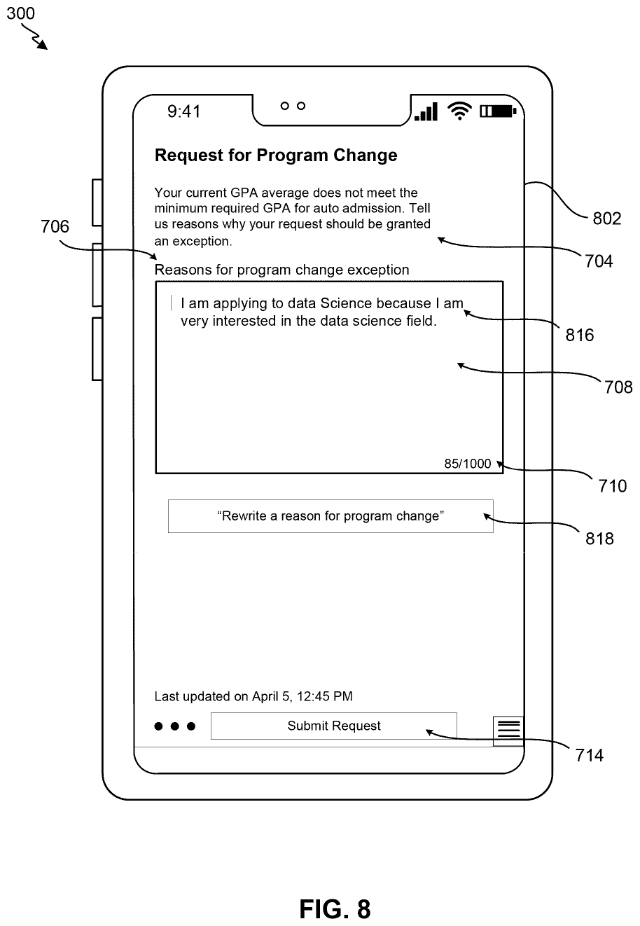

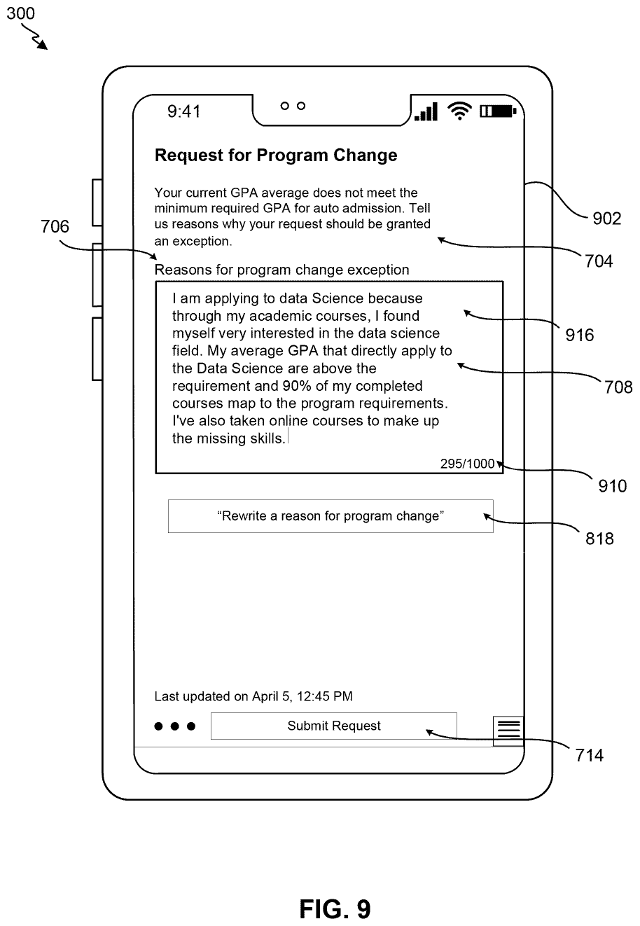

FIG. 7 shows an interface 702 for a student to request a change of an academic pathway. As shown, the interface 702 includes a text input region 708 to input one or more items of data supporting or justifying the requested change. FIG. 8 shows the interface 802 with a natural language text input field 818 in addition to the text input regions 708 for inputting one or more items of data supporting or justifying the requested change, and includes sample data 816 that has been inputted in an example. The natural language text input field receives natural language text, and the academic planning system loads a prompt template to request text for requesting a program change. The prompt template may include dynamically determined variables that are filled into placeholder positions prior to prompting a large language model. The dynamically determined variables may include, for example, structured data indicating which degree the user is changing from, which degree the user is changing to, an overall impact of the change, a score for the alternative academic pathway, a finance-related portion of the impact such as financial aid or expense, a course credit portion of the impact such as number of credits needed, a time to graduation portion of the impact, and/or jobs, skills, and/or interests affected by the change. The LLM may receive these variables and be prompted to generate a well-reasoned request for a program change, as shown in interface 902 by generated request 916 in FIG. 9 with updated character limit indication 910.

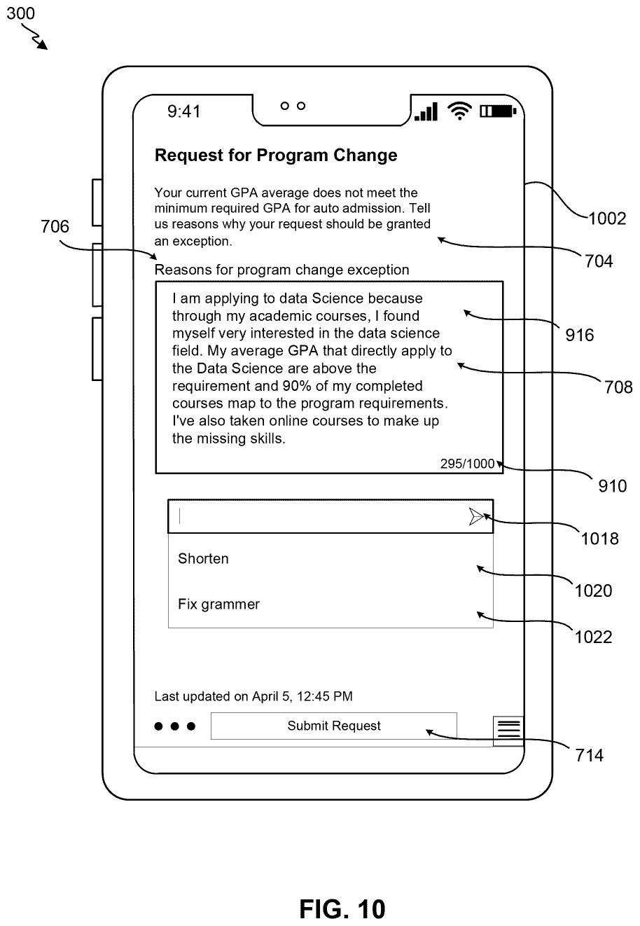

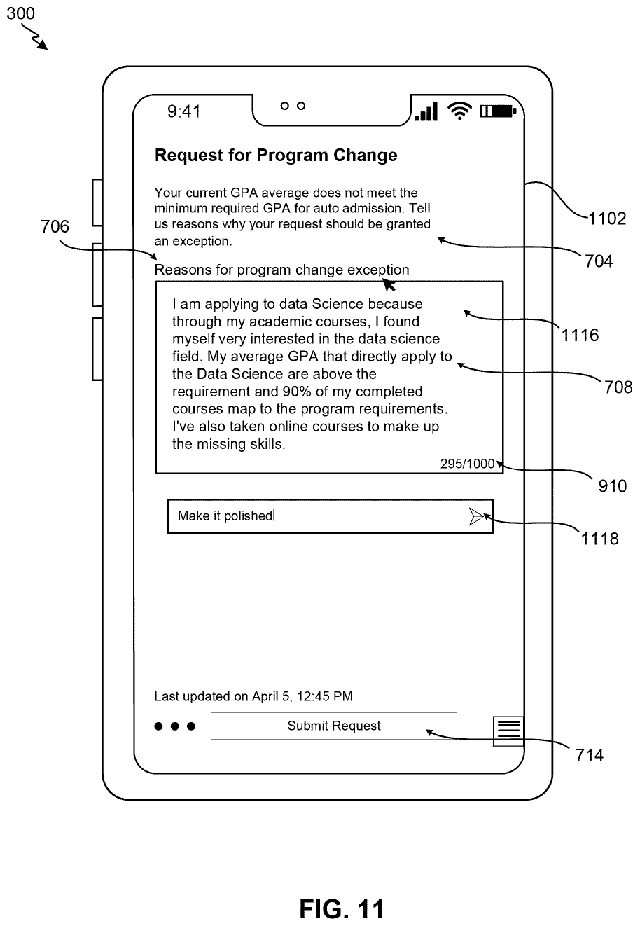

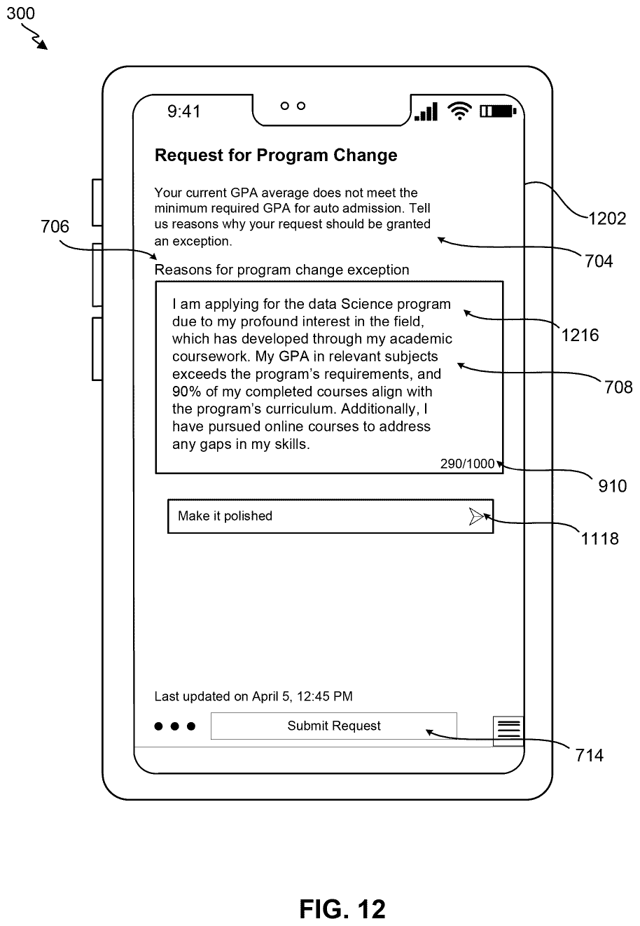

As shown in interface 1002 of FIG. 10, the natural language input region 1018 may include a drop-down menu of selectable options 1020 and 1022 to make the reasons shorter or to fix grammar for reasons already entered, whether generated by the LLM or not. In other words, existing change requests 916 or 816, for example, may be revised by the natural language input, which is provided to the LLM to generate a revised version 1116 of the change request. In one embodiment, for revising a change request, the LLM is prompted with existing change request text 916 or 816, for example, that is displayed in the text input region 708 as well as instructions to change the existing change request text according to the natural language input revision instructions 1118, for example. FIG. 11 shows an example user input to the natural language input region 1118 indicating that the reasons should be polished or made more professional or formal. As a result of the request in FIG. 11, the LLM is prompted with the structured data, such as data from field(s) and/or section(s) shown in FIGS. 6A-6E, as well as prior reasons 1116, 916, 816, for example, and the user input request 1118. The LLM returns a new reason 1216, which is then shown in the main text input region 708 as shown in FIG. 12. The reason 1216 may be submitted with the request using option 714 when the user is satisfied with the content.

### Interface and Logic for Approving Change Requests

In one embodiment, change requests are processed using a tiered architecture. Change requests associated with conditions in which all conditions have a high likelihood of approval based on prior approvals historically made for other students may be automatically approved or placed in a batch for batch review and approval by an administrator. The administrator may set tolerances or thresholds for automatic approval, batch approval, and/or manual review for individual characteristics, pathway changes, date restrictions (e.g., restricting changes after or before a certain date or distance in the current or target academic pathway), likelihoods of approval specific to certain characteristics, and/or likelihoods of approval detected by machine learning regardless of which characteristic the likelihood is detected for. These administrator settings may be different for different administrators corresponding to different academic pathways or different groups of academic pathways (e.g., colleges within a university), and the settings may be stored in association with each academic pathway or group.

In one example, the high likelihoods may account for historical treatments of course equivalencies, exceptions needed or not needed, source and target academic pathway pairings that are common, student enrollment or admission caps for certain academic pathways, and financial aid and tuition changes made, etc. In scenarios of low or medium likelihood of approval, the change requests may be placed in a queue with each change request flagged based on the low or medium likelihood conditions. The administrator may review the low or medium likelihood conditions as flagged for each request and determine whether exceptions are to be granted or not for the request. By focusing the attention of the administrator on the portions of the request that carry low or medium likelihoods of approval, the academic planning system is able to efficiently carry change requests to resolution as approved, rejected, or further action needed.

If further action needed is identified by the administrator, such action may be learned by the academic planning system for recommendation in association with future change requests. The further action needed may be immediate action or may be satisfied over terms, such as improving a GPA or taking and attaining a certain grade in certain prerequisite courses. Conditions or prerequisites may be populated in an academic planning interface for the student, where the student can proceed to satisfy the conditions by, for example, scheduling a meeting in response to a message in the interface, or confirming or agreeing that a GPA will be maintained at a certain level for a period of time after the change. For example, the program explorer interface may include an option to schedule a meeting with an administrator to transform an unsatisfied condition for a target academic pathway to a satisfied condition for the target academic pathway.

As conditions are satisfied for an open change request, an administrator may be prompted to approve or confirm that the conditions have been satisfied. For example, a student indication that a meeting has been held may be confirmed by an administrator that indicates the meeting occurred and/or that the change request is approved.

### Corporate Training or Certification Embodiments

In various embodiments, a change of pathway may be evaluated in a variety of contexts other than an academic change of major or program context. For example, a change of pathway may be evaluated for a change of specialization, change of certification targets for employees, change in professional development activities, etc. These various changes of pathways may be associated with different costs, different times of completion, different credits to the individual, and/or cater or be synergistic with different skills, qualifications, and/or interests. Techniques described herein may be used to suggest a change of pathway in each of these contexts, accounting for relevant information to the change of pathway and incorporating structured feedback from a large language model based on the relevant information.

### Agent Architecture for Determining Factors Contributing to a Change of Pathway

In various embodiments, a multi-agent architecture may include a variety of agents each separately configured to interact with a same or different large language model, with same or different prompt templates, and use same or different tools and/or same or different retrieval augmented generation (RAG) data sources or other data sources to enrich prompts or post-process results from prompts to the large language model. The different agents may use different processes before or after prompting the large language model, and different types or amounts of data in the prompts or added to the results.

In one embodiment, a pathway planner supervisor agent may determine an intent of a user to evaluate one or more changes of pathways, for example, based on user input(s) to or selection(s) from a navigation interface and/or user text input(s). The pathway planner supervisor agent may interact with a plurality of worker agents to gather information and/or determine what information to display or option(s) to display to the user based on the detected intent. Information gathered from the individual agents may be combined or otherwise accounted for by the pathway planner supervisor agent in generating information or option(s) to display via an interface of dynamic content and structure controlled by the pathway planner supervisor agent.

In various examples, the worker agents may include:
a financial impact agent that determines what information to display and/or option(s) to display relating to the net impact (e.g., financial impact) of the source and/or target academic or other pathway(s),
a financial aid agent that determines what information to display and/or option(s) to display relating to the financial aid impact of the source and/or target academic or other pathways,
an expense agent that determines what information to display and/or option(s) to display relating to the expenses associated with the source and/or target academic or other pathways,
a course or training credit agent that determines what training or credits will carry over to source and/or target academic or other pathway(s),
a qualification agent that determines qualifications needed to pursue the source and/or target academic or other pathway(s),
a skills or competencies agent that determines what skills or competencies are exhibited (e.g., determined from a user profile, badges, certifications, resume, course work listing, or work experience log) associated with or relevant to (e.g., via semantic similarity of content vector embeddings) the source and/or target academic or other pathway(s), and/or
an interests agent that determines interests (e.g., determined from a user profile, resume, course work listing, or work experience log) associated with or relevant to the source and/or target academic or other pathway(s).

In one embodiment, the financial impact agent has access to private data source(s) relating to finances of the individual considering a change of pathway, and other agent(s) do not have access to the private data source(s). In this manner, interfaces used to help make decisions based on other factors may be prevented from considering financial information, and the financial impact agent may be prevented from considering academic information of the individual, preventing bias in both directions that may otherwise be present if a centralized decisionmaker or control system made these different recommendations together.

When presenting information to a supervising agent such as the pathway planner supervisor agent, individual worker agents may mask private data from private datasets and reflect the private data in terms of a score that accounts for the private data without revealing the details. For example, the pathway planner supervisor agent may receive a score that indicates how much a cost will change between different pathways and/or how important that cost change is to the individual without providing underlying reasons why the cost change is important to the individual (e.g., due to a low annual income, past due balance, high cost of living, family reasons, etc.).

In various embodiments, one or more artificial intelligence agents may be tasked with controlling interface functionality and/or generating information in support of interface functionality for one or more decisions being considered by the user as evidenced via user input. Each artificial intelligence agent may be trained or configured to perform specific tasks with regards to such information such as generating a prompt for execution by a large language model and/or performing tasks of generating or interpreting data.

The one or more artificial intelligence agents may be specific to a certain type of information or use case. For example, an artificial intelligence agent may be trained or configured only using information or processes relating to financial data or in support of finance-related functionality or interface tools used in finance reporting, in which case the artificial intelligence agent may be specific to the handling of or generation of information relating to financial data such as financial history or forecasts, financial aid history or forecasts, payment history or forecasts, or visualizations thereof. Another artificial intelligence agent may be trained or configured only using academic data or processes or in support of academic reporting functionality or interface tools used in academic reporting, in which case the artificial intelligence agent may be specific to handling of or generation of information relating to academic data such as academic history or forecast information, information about courses, credits, credit transfers, or visualizations thereof.

In yet another example, an artificial intelligence agent may be assigned to only perform operations relating to a certain set of parameters of data within a set of data and may be utilized only in the case where parameter(s) of the certain set of parameters of data are present within the project information or have been determined to be relevant for generating the requested information. For example, different agents may support different sets of students or students from different programs or colleges.

An artificial intelligence agent may be specific to a certain role or task such as generating summaries, rephrasing text, generating visualizations, generating views, updating views, updating visualizations, generating data specific to another different application or content consumer, or analyzing displayed data. The artificial intelligence agent may use, in prompts to the large language model, domain knowledge specific to triggering functionality corresponding to the task or type of task for which the agent is typically assigned.

One or more artificial intelligence agents may be selected for processing information by first determining a type of information or use case. The determined type of information or use case may then be compared to a type of information or use case associated with each artificial intelligence agent of a plurality of pre-trained and/or pre-configured artificial intelligence agents. The information may be determined to include a plurality of types of data, such as information relating to multiple different items of requested or relevant application functionality or information, in which case the different items of requested or relevant application functionality may be triggered and/or information generated using a plurality of artificial intelligence agents. The agents may be coordinated as worker agents by a supervising agent, and the supervising agent may merge results from the worker agents into a combined result, such as a user interface including multiple components for display.

Different artificial intelligence agents may have different tools or accesses to input information based on their different use cases. For example, one artificial intelligence agent may have access to a set of private data that another artificial intelligence agent does not have access to in order to prevent the set of private data being publicly disclosed. As another example, any agent may have access to external data, such as an external news feed specific to a set of data, that is not accessible to the other agent(s).

In one embodiment, a managing agent determines one or more types of information being analyzed, and the managing agent assigns one or more worker agents specialized to handle each of the one or more types determined. The worker agents may analyze the information with the assistance of generative artificial intelligence, one or more customized prompt templates optionally specific to the corresponding worker agent, and/or one or more customized tools optionally specific to the to the corresponding worker agent. The managing agent may then assemble results from the one or more worker agents to provide a cohesive combined result for causing application functionality.

The one or more artificial intelligence agents may perform additional tasks prior to or after prompting a large language model for generating information relevant to the type of information or use case associated with the agent. For example, an artificial intelligence agent used for summarizing information involving personally identifiable information may perform an extra step prior to generating a prompt of removing or masking certain personally identifiable information from the data such that the personally identifiable information is not exposed to the large language model. In another example, the same artificial intelligence agent may, after generating a prompt and prompting a large language model to generate a summary, perform an extra step of analyzing the generated summary and editing the summary or re-prompting the large language model to generate a new summary when aspects of the summary indicate a bias. The additional tasks may be facilitated by a set of tools accessible by the one or more artificial intelligence agents such as access to submit API calls, other machine learning models, templates, or access to further artificial intelligence agents.

Access to the set of tools by artificial intelligence agents may be managed by using one or more authentication keys. The one or more authentication keys may determine which artificial intelligence agents access which tools by controlling access to the authentication keys for each artificial intelligence agent. A first artificial intelligence agent may, for example, have access to an API as a tool via access to one or more authentication keys that are inaccessible to a second artificial intelligence agent. The authentication keys may be simple, static credentials issued to identify applications accessing a tool such as an API. The authentication key may be included in an access request to a tool such as in a request header or URL parameter to an API. In one example, API keys may include credentials issued to identify applications (e.g., the data management system, etc.) accessing an API, and may be included in request headers, URL parameters, etc., without necessarily having a built-in expiration or user-based access control.

An authentication key may also be a temporary access token granted after authentication such that access to the tool is time-limited. An authentication key may also be a credential of a set of credentials such as a username and password, such as for accessing a tool via a user's login, where the user is the current user requesting a summary to be generated by the artificial intelligence agent. For example, bearer tokens (e.g., OAuth 2.0, etc.) may include temporary access tokens (e.g., granted after a more comprehensive authentication such as OAuth 2.0), allowing secure, time-limited access to resources (e.g., agent tools) without necessarily exposing credentials.

Other methods for accessing agent tools may include ‘Basic Authentication’, which is a process that involves sending a username and password encoded in a request (e.g., HTTP request, HTTPS request, etc.). Another example authentication mechanism includes JSON Web Tokens (JWT), which encode user information for token-based authentication. Another example authentication mechanism includes Mutual TLS (mTLS) which could add an extra layer of security by requiring client and server devices to authenticate each other using certificates. Another example authentication mechanism includes Hash-based Message authentication code (HMAC), where message integrity may be ensured by signing requests with a secret key. Other authentication mechanisms are possible as well depending on security requirements or preferences, user-specific access requirements or preferences, and/or sensitivity of data retrieved using the agent tools, among other factors.

In various embodiments, different agents may have access to different authentication mechanisms and/or different authentication keys, shared secrets, or other authentication parameters, which may provide different levels of access to the different agents. The same or different level(s) of access to same or different tool(s) may be driven by same or different authentication parameter(s) used by the different agents, and the authentication parameter(s) may be communicated to same or different API(s) that support tool functionality, which may have access to same or different set(s) of data in a back-end database, such as access that is driven by role(s) or security profile(s) associated with the authentication parameters provided to authenticate for API use and/or separate role(s) or security profile(s) managed by the tool that provides data lookup, analysis, management, data generation or other content generation, or other functionality to the agent(s).

The set of tools accessible by the one or more artificial intelligence agents may be specific to the artificial intelligence agent or the use case of the artificial intelligence agent, such as access to a personnel management toolkit for pre-processing or post-processing data outside of an LLM prompt or response. The tool(s) accessible by an artificial intelligence agent for a human resources use case might not be accessible by artificial intelligence agents of other use cases so as to not expose personally identifiable information to other artificial intelligence agents. The set of tools accessible by the one or more artificial intelligence agents may also be a generic tool used to facilitate any artificial intelligence agent in the performance of tasks specific to their use case, such as a data search tool used by an artificial intelligence agent to determine the specific parameters or sets of data relevant to its use case.

In one example, the one or more artificial intelligence agents includes a managing artificial intelligence agent, which instantiates each of the one or more artificial intelligence agents used in generating relevant information. The managing artificial intelligence agent may determine a number of other artificial intelligence agents to use for generating each item of relevant information, such as by processing or performing semantic search on a relevant type of information or use case, or a type of information or use case with a vector embedding similar to an item of relevant information. The managing artificial intelligence agent may also determine an order of operations to perform by different agents and how results of the operations are to be combined together, and/or how agent(s) should coordinate with each other to produce results.

The one or more artificial intelligence agents may communicate between each other by sharing information, analyses, and/or generated content based on same or different inputs. For example, a first artificial intelligence agent may be tasked with performing data analysis and pre-processing on a set of data, such as by applying one or more operations on a set of data to prepare the data for further analysis, and the results of the first artificial intelligence agent may be provided to a second artificial intelligence agent for generating a information such as a data structure to trigger UI functionality, for example, by interacting with a large language model. Artificial intelligence agents may share information including information detected by the artificial intelligence agent to be relevant for an agent-specific use case. For example, a number of artificial intelligence agents may generate information about separate sets of data, such as how such data should be displayed in an interface, and may send information about their separate sets of data to another artificial intelligence agent tasked with generating information about all of the sets of data, such as how to combine the different presentations of data into a combined data presentation, such as a view, summary, or visualization.

### Computer System Architecture

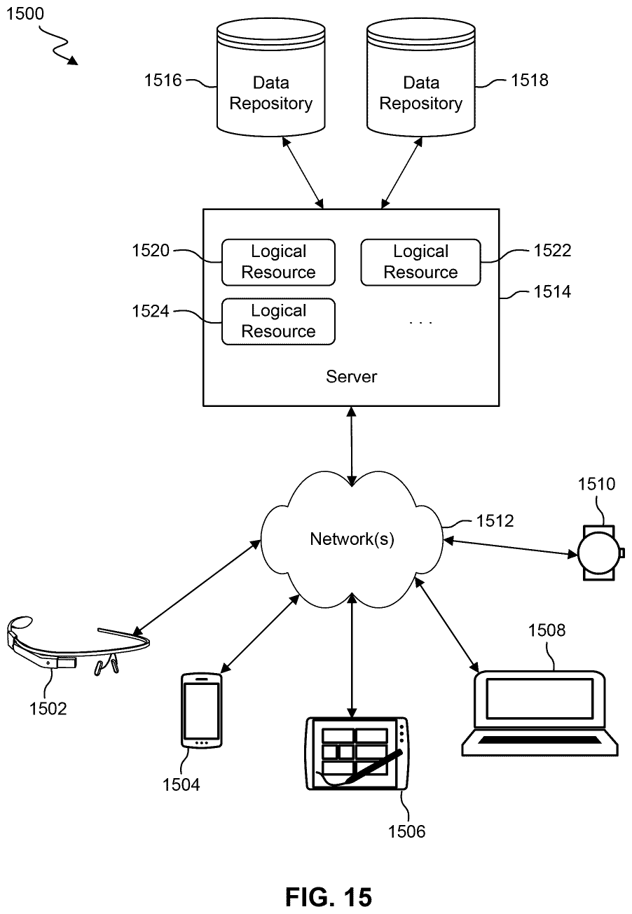

FIG. 15 depicts a simplified diagram of a distributed system 1500 for implementing an embodiment. In the illustrated embodiment, distributed system 1500 includes one or more client computing devices 1502, 1504, 1506, 1508, and/or 1510 coupled to a server 1514 via one or more communication networks 1512. Clients computing devices 1502, 1504, 1506, 1508, and/or 1510 may be configured to execute one or more applications.

In various aspects, server 1514 may be adapted to run one or more services or software applications that enable techniques for generating for a student different scores for different alternative academic pathways based at least in part on various factors, and initiating a change request that may be completed in a modifiable manner by a large language model using a prompt that informs the large language model of the factors for the student.

In certain aspects, server 1514 may also provide other services or software applications that can include non-virtual and virtual environments. In some aspects, these services may be offered as web-based or cloud services, such as under a Software as a Service (SaaS) model to the users of client computing devices 1502, 1504, 1506, 1508, and/or 1510. Users operating client computing devices 1502, 1504, 1506, 1508, and/or 1510 may in turn utilize one or more client applications to interact with server 1514 to utilize the services provided by these components.

In the configuration depicted in FIG. 15, server 1514 may include one or more components 1520, 1522 and 1524 that implement the functions performed by server 1514. These components may include software components that may be executed by one or more processors, hardware components, or combinations thereof. It should be appreciated that various different system configurations are possible, which may be different from distributed system 1500. The embodiment shown in FIG. 15 is thus one example of a distributed system for implementing an embodiment system and is not intended to be limiting.

Users may use client computing devices 1502, 1504, 1506, 1508, and/or 1510 for techniques for generating for a student different scores for different alternative academic pathways based at least in part on various factors, and initiating a change request that may be completed in a modifiable manner by a large language model using a prompt that informs the large language model of the factors for the student in accordance with the teachings of this disclosure. A client device may provide an interface that enables a user of the client device to interact with the client device. The client device may also output information to the user via this interface. Although FIG. 15 depicts only five client computing devices, any number of client computing devices may be supported.

The client devices may include various types of computing systems such as smart phones or other portable handheld devices, general purpose computers such as personal computers and laptops, workstation computers, personal assistant devices, smart watches, smart glasses, or other wearable devices, equipment firmware, gaming systems, thin clients, various messaging devices, sensors or other sensing devices, and the like. These computing devices may run various types and versions of software applications and operating systems (e.g., Microsoft Windows®, Apple Macintosh®, UNIX® or UNIX-like operating systems, Linux® or Linux-like operating systems such as Oracle® Linux and Google Chrome® OS) including various mobile operating systems (e.g., Microsoft Windows Mobile®, iOS®, Windows Phone®, Android®, HarmonyOS®, Tizen®, KaiOS®, Sailfish® OS, Ubuntu® Touch, CalyxOS®). Portable handheld devices may include cellular phones, smartphones, (e.g., an iPhone®), tablets (e.g., iPad®), and the like. Virtual personal assistants such as Amazon® Alexa®, Google® Assistant, Microsoft® Cortana®, Apple® Siri®, and others may be implemented on devices with a microphone and/or camera to receive user or environmental inputs, as well as a speaker and/or display to respond to the inputs. Wearable devices may include Apple® Watch, Samsung Galaxy® Watch, Meta Quest®, Ray-Ban® Meta® smart glasses, Snap® Spectacles, and other devices. Gaming systems may include various handheld gaming devices, Internet-enabled gaming devices (e.g., a Microsoft Xbox® gaming console with or without a Kinect® gesture input device, Sony PlayStation® system, Nintendo Switch®, and other devices), and the like. The client devices may be capable of executing various different applications such as various Internet-related apps, communication applications (e.g., e-mail applications, short message service (SMS) applications) and may use various communication protocols.

Network(s) 1512 may be any type of network familiar to those skilled in the art that can support data communications using any of a variety of available protocols, including without limitation TCP/IP (transmission control protocol/Internet protocol), SNA (systems network architecture), IPX (Internet packet exchange), AppleTalk®, and the like. Merely by way of example, network(s) 1512 can be a local area network (LAN), networks based on Ethernet, Token-Ring, a wide-area network (WAN), the Internet, a virtual network, a virtual private network (VPN), an intranet, an extranet, a public switched telephone network (PSTN), an infra-red network, a wireless network (e.g., a network operating under any of the Institute of Electrical and Electronics (IEEE) 1002.11 suite of protocols, Bluetooth®, and/or any other wireless protocol), and/or any combination of these and/or other networks.

Server 1514 may be composed of one or more general purpose computers, specialized server computers (including, by way of example, PC (personal computer) servers, UNIX® servers, LINIX® servers, mid-range servers, mainframe computers, rack-mounted servers, etc.), server farms, server clusters, a Real Application Cluster (RAC), database servers, or any other appropriate arrangement and/or combination. Server 1514 can include one or more virtual machines running virtual operating systems, or other computing architectures involving virtualization such as one or more flexible pools of logical storage devices that can be virtualized to maintain virtual storage devices for the server. In various aspects, server 1514 may be adapted to run one or more services or software applications that provide the functionality described in the foregoing disclosure.

The computing systems in server 1514 may run one or more operating systems including any of those discussed above, as well as any commercially available server operating system. Server 1514 may also run any of a variety of additional server applications and/or mid-tier applications, including HTTP (hypertext transport protocol) servers, FTP (file transfer protocol) servers, CGI (common gateway interface) servers, JAVA® servers, database servers, and the like. Exemplary database servers include without limitation those commercially available from Oracle®, Microsoft®, SAP®, Amazon®, Sybase®, IBM® (International Business Machines), and the like.

In some implementations, server 1514 may include one or more applications to analyze and consolidate data feeds and/or event updates received from users of client computing devices 1502, 1504, 1506, 1508, and/or 1510. As an example, data feeds and/or event updates may include, but are not limited to, blog feeds, Threads® feeds, Twitter® feeds, Facebook® updates or real-time updates received from one or more third party information sources and continuous data streams, which may include real-time events related to sensor data applications, financial tickers, network performance measuring tools (e.g., network monitoring and traffic management applications), clickstream analysis tools, automobile traffic monitoring, and the like. Server 1514 may also include one or more applications to display the data feeds and/or real-time events via one or more display devices of client computing devices 1502, 1504, 1506, 1508, and/or 1510.

Distributed system 1500 may also include one or more data repositories 1516, 1518. These data repositories may be used to store data and other information in certain aspects. For example, one or more of the data repositories 1516, 1518 may be used to store information for techniques for generating for a student different scores for different alternative academic pathways based at least in part on various factors, and initiating a change request that may be completed in a modifiable manner by a large language model using a prompt that informs the large language model of the factors for the student. Data repositories 1516, 1518 may reside in a variety of locations. For example, a data repository used by server 1514 may be local to server 1514 or may be remote from server 1514 and in communication with server 1514 via a network-based or dedicated connection. Data repositories 1516, 1518 may be of different types. In certain aspects, a data repository used by server 1514 may be a database, for example, a relational database, a container database, an Exadata® storage device, or other data storage and retrieval tool such as databases provided by Oracle Corporation® and other vendors. One or more of these databases may be adapted to enable storage, update, and retrieval of data to and from the database in response to structured query language (SQL)-formatted commands.

In certain aspects, one or more of data repositories 1516, 1518 may also be used by applications to store application data. The data repositories used by applications may be of different types such as, for example, a key-value store repository, an object store repository, or a general storage repository supported by a file system.

In one embodiment, server 1514 is part of a cloud-based system environment in which various services may be offered as cloud services, for a single tenant or for multiple tenants where data, requests, and other information specific to the tenant are kept private from each tenant. In the cloud-based system environment, multiple servers may communicate with each other to perform the work requested by client devices from the same or multiple tenants. The servers communicate on a cloud-side network that is not accessible to the client devices in order to perform the requested services and keep tenant data confidential from other tenants.

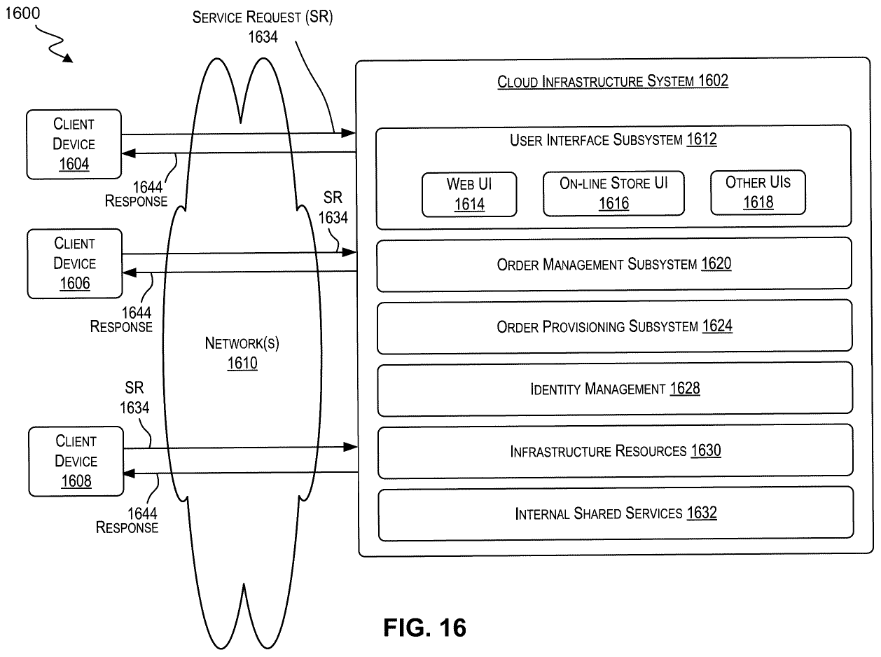

FIG. 16 is a simplified block diagram of a cloud-based system environment in which different scores are generated for a student for different alternative academic pathways based at least in part on various factors, and a change request is initiated that may be completed in a modifiable manner by a large language model using a prompt that informs the large language model of the factors for the student, in accordance with certain aspects. In the embodiment depicted in FIG. 16, cloud infrastructure system 1602 may provide one or more cloud services that may be requested by users using one or more client computing devices 1604, 1606, and 1608. Cloud infrastructure system 1602 may comprise one or more computers and/or servers that may include those described above for server 1514. The computers in cloud infrastructure system 1602 may be organized as general purpose computers, specialized server computers, server farms, server clusters, or any other appropriate arrangement and/or combination.

Network(s) 1610 may facilitate communication and exchange of data between clients 1604, 1606, and 1608 and cloud infrastructure system 1602. Network(s) 1610 may include one or more networks. The networks may be of the same or different types. Network(s) 1610 may support one or more communication protocols, including wired and/or wireless protocols, for facilitating the communications.

The embodiment depicted in FIG. 16 is only one example of a cloud infrastructure system and is not intended to be limiting. It should be appreciated that, in some other aspects, cloud infrastructure system 1602 may have more or fewer components than those depicted in FIG. 16, may combine two or more components, or may have a different configuration or arrangement of components. For example, although FIG. 16 depicts three client computing devices, any number of client computing devices may be supported in alternative aspects.

The term cloud service is generally used to refer to a service that is made available to users on demand and via a communication network such as the Internet by systems (e.g., cloud infrastructure system 1602) of a service provider. Typically, in a public cloud environment, servers and systems that make up the cloud service provider's system are different from the cloud customer's (“tenant's”) own on-premise servers and systems. The cloud service provider's systems are managed by the cloud service provider. Tenants can thus avail themselves of cloud services provided by a cloud service provider without having to purchase separate licenses, support, or hardware and software resources for the services. For example, a cloud service provider's system may host an application, and a user may, via a network 1610 (e.g., the Internet), on demand, order and use the application without the user having to buy infrastructure resources for executing the application. Cloud services are designed to provide easy, scalable access to applications, resources, and services. Several providers offer cloud services. For example, several cloud services are offered by Oracle Corporation®, such as database services, middleware services, application services, and others.

In certain aspects, cloud infrastructure system 1602 may provide one or more cloud services using different models such as under a Software as a Service (SaaS) model, a Platform as a Service (PaaS) model, an Infrastructure as a Service (IaaS) model, a Data as a Service (DaaS) model, and others, including hybrid service models. Cloud infrastructure system 1602 may include a suite of databases, middleware, applications, and/or other resources that enable provision of the various cloud services.

A SaaS model enables an application or software to be delivered to a tenant's client device over a communication network like the Internet, as a service, without the tenant having to buy the hardware or software for the underlying application. For example, a SaaS model may be used to provide tenants access to on-demand applications that are hosted by cloud infrastructure system 1602. Examples of SaaS services provided by Oracle Corporation® include, without limitation, various services for human resources/capital management, client relationship management (CRM), enterprise resource planning (ERP), supply chain management (SCM), enterprise performance management (EPM), analytics services, social applications, and others.

An IaaS model is generally used to provide infrastructure resources (e.g., servers, storage, hardware, and networking resources) to a tenant as a cloud service to provide elastic compute and storage capabilities. Various IaaS services are provided by Oracle Corporation®.

A PaaS model is generally used to provide, as a service, platform and environment resources that enable tenants to develop, run, and manage applications and services without the tenant having to procure, build, or maintain such resources. Examples of PaaS services provided by Oracle Corporation® include, without limitation, Oracle Database Cloud Service (DBCS), Oracle Java Cloud Service (JCS), data management cloud service, various application development solutions services, and others.

A DaaS model is generally used to provide data as a service. Datasets may searched, combined, summarized, and downloaded or placed into use between applications. For example, user profile data may be updated by one application and provided to another application. As another example, summaries of user profile information generated based on a dataset may be used to enrich another dataset.

Cloud services are generally provided on an on-demand self-service basis, subscription-based, elastically scalable, reliable, highly available, and secure manner. For example, a tenant, via a subscription order, may order one or more services provided by cloud infrastructure system 1602. Cloud infrastructure system 1602 then performs processing to provide the services requested in the tenant's subscription order. Cloud infrastructure system 1602 may be configured to provide one or even multiple cloud services.

Cloud infrastructure system 1602 may provide the cloud services via different deployment models. In a public cloud model, cloud infrastructure system 1602 may be owned by a third party cloud services provider and the cloud services are offered to any general public tenant, where the tenant can be an individual or an enterprise. In certain other aspects, under a private cloud model, cloud infrastructure system 1602 may be operated within an organization (e.g., within an enterprise organization) and services provided to clients that are within the organization. For example, the clients may be various departments or employees or other individuals of departments of an enterprise such as the Human Resources department, the Payroll department, etc., or other individuals of the enterprise. In certain other aspects, under a community cloud model, the cloud infrastructure system 1602 and the services provided may be shared by several organizations in a related community. Various other models such as hybrids of the above mentioned models may also be used.

Client computing devices 1604, 1606, and 1608 may be of different types (such as devices 1502, 1504, 1506, and 1508 depicted in FIG. 15) and may be capable of operating one or more client applications. A user may use a client device to interact with cloud infrastructure system 1602, such as to request a service provided by cloud infrastructure system 1602.

In some aspects, the processing performed by cloud infrastructure system 1602 for providing chatbot services may involve big data analysis. This analysis may involve using, analyzing, and manipulating large data sets to detect and visualize various trends, behaviors, relationships, etc. within the data. This analysis may be performed by one or more processors, possibly processing the data in parallel, performing simulations using the data, and the like. For example, big data analysis may be performed by cloud infrastructure system 1602 for determining the intent of an utterance. The data used for this analysis may include structured data (e.g., data stored in a database or structured according to a structured model) and/or unstructured data (e.g., data blobs (binary large objects)).

As depicted in the embodiment in FIG. 16, cloud infrastructure system 1602 may include infrastructure resources 1630 that are utilized for facilitating the provision of various cloud services offered by cloud infrastructure system 1602. Infrastructure resources 1630 may include, for example, processing resources, storage or memory resources, networking resources, and the like.

In certain aspects, to facilitate efficient provisioning of these resources for supporting the various cloud services provided by cloud infrastructure system 1602 for different tenants, the resources may be bundled into sets of resources or resource modules (also referred to as “pods”). Each resource module or pod may comprise a pre-integrated and optimized combination of resources of one or more types. In certain aspects, different pods may be pre-provisioned for different types of cloud services. For example, a first set of pods may be provisioned for a database service, a second set of pods, which may include a different combination of resources than a pod in the first set of pods, may be provisioned for Java service, and the like. For some services, the resources allocated for provisioning the services may be shared between the services.

Cloud infrastructure system 1602 may itself internally use services 1632 that are shared by different components of cloud infrastructure system 1602 and which facilitate the provisioning of services by cloud infrastructure system 1602. These internal shared services may include, without limitation, a security and identity service, an integration service, an enterprise repository service, an enterprise manager service, a virus scanning and whitelist service, a high availability, backup and recovery service, service for enabling cloud support, an email service, a notification service, a file transfer service, and the like.

Cloud infrastructure system 1602 may comprise multiple subsystems. These subsystems may be implemented in software, or hardware, or combinations thereof. As depicted in FIG. 16, the subsystems may include a user interface subsystem 1612 that enables users of cloud infrastructure system 1602 to interact with cloud infrastructure system 1602. User interface subsystem 1612 may include various different interfaces such as a web interface 1614, an online store interface 1616 where cloud services provided by cloud infrastructure system 1602 are advertised and are purchasable by a consumer, and other interfaces 1618. For example, a tenant may, using a client device, request (service request 1634) one or more services provided by cloud infrastructure system 1602 using one or more of interfaces 1614, 1616, and 1618. For example, a tenant may access the online store, browse cloud services offered by cloud infrastructure system 1602, and place a subscription order for one or more services offered by cloud infrastructure system 1602 that the tenant wishes to subscribe to. The service request may include information identifying the tenant and one or more services that the tenant desires to subscribe to. For example, a tenant may place a subscription order for a chatbot related service offered by cloud infrastructure system 1602. As part of the order, the client may provide information identifying the input (e.g. utterances).

In certain aspects, such as the embodiment depicted in FIG. 16, cloud infrastructure system 1602 may comprise an order management subsystem (OMS) 1620 that is configured to process the new order. As part of this processing, OMS 1620 may be configured to: create an account for the tenant, if not done already; receive billing and/or accounting information from the tenant that is to be used for billing the tenant for providing the requested service to the tenant; verify the tenant information; upon verification, book the order for the tenant; and orchestrate various workflows to prepare the order for provisioning.

Once properly validated, OMS 1620 may then invoke the order provisioning subsystem (OPS) 1624 that is configured to provision resources for the order including processing, memory, and networking resources. The provisioning may include allocating resources for the order and configuring the resources to facilitate the service requested by the tenant order. The manner in which resources are provisioned for an order and the type of the provisioned resources may depend upon the type of cloud service that has been ordered by the tenant. For example, according to one workflow, OPS 1624 may be configured to determine the particular cloud service being requested and identify a number of pods that may have been pre-configured for that particular cloud service. The number of pods that are allocated for an order may depend upon the size/amount/level/scope of the requested service. For example, the number of pods to be allocated may be determined based upon the number of users to be supported by the service, the duration of time for which the service is being requested, and the like. The allocated pods may then be customized for the particular requesting tenant for providing the requested service.

Cloud infrastructure system 1602 may send a response or notification 1644 to the requesting tenant to indicate when the requested service is now ready for use. In some instances, information (e.g., a link) may be sent to the tenant that enables the tenant to start using and availing the benefits of the requested services.

Cloud infrastructure system 1602 may provide services to multiple tenants. For each tenant, cloud infrastructure system 1602 is responsible for managing information related to one or more subscription orders received from the tenant, maintaining tenant data related to the orders, and providing the requested services to the tenant or clients of the tenant. Cloud infrastructure system 1602 may also collect usage statistics regarding a tenant's use of subscribed services. For example, statistics may be collected for the amount of storage used, the amount of data transferred, the number of users, and the amount of system up time and system down time, and the like. This usage information may be used to bill the tenant. Billing may be done, for example, on a monthly cycle.

Cloud infrastructure system 1602 may provide services to multiple tenants in parallel. Cloud infrastructure system 1602 may store information for these tenants, including possibly proprietary information. In certain aspects, cloud infrastructure system 1602 comprises an identity management subsystem (IMS) 1628 that is configured to manage tenant's information and provide the separation of the managed information such that information related to one tenant is not accessible by another tenant. IMS 1628 may be configured to provide various security-related services such as identity services, such as information access management, authentication and authorization services, services for managing tenant identities and roles and related capabilities, and the like.

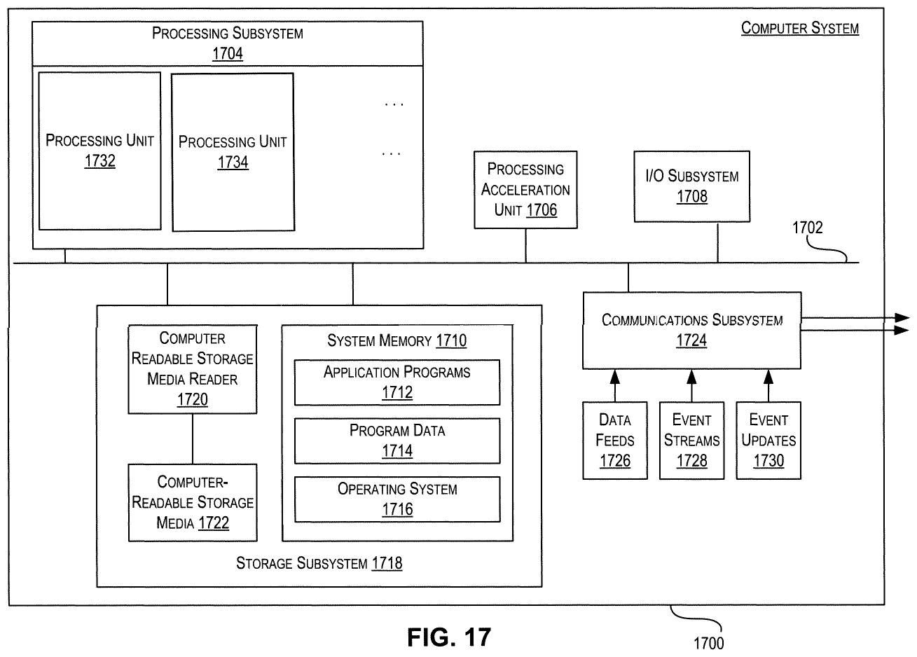

FIG. 17 illustrates an exemplary computer system 1700 that may be used to implement certain aspects. As shown in FIG. 17, computer system 1700 includes various subsystems including a processing subsystem 1704 that communicates with a number of other subsystems via a bus subsystem 1702. These other subsystems may include a processing acceleration unit 1706, an I/O subsystem 1708, a storage subsystem 1718, and a communications subsystem 1724. Storage subsystem 1718 may include non-transitory computer-readable storage media including storage media 1722 and a system memory 1710.

Bus subsystem 1702 provides a mechanism for letting the various components and subsystems of computer system 1700 communicate with each other as intended. Although bus subsystem 1702 is shown schematically as a single bus, alternative aspects of the bus subsystem may utilize multiple buses. Bus subsystem 1702 may be any of several types of bus structures including a memory bus or memory controller, a peripheral bus, a local bus using any of a variety of bus architectures, and the like. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard, and the like.

Processing subsystem 1704 controls the operation of computer system 1700 and may comprise one or more processors, application specific integrated circuits (ASICs), or field programmable gate arrays (FPGAs). The processors may be single core or multicore processors. The processing resources of computer system 1700 can be organized into one or more processing units 1732, 1734, etc. A processing unit may include one or more processors, one or more cores from the same or different processors, a combination of cores and processors, or other combinations of cores and processors. In some aspects, processing subsystem 1704 can include one or more special purpose co-processors such as graphics processors, digital signal processors (DSPs), or the like. In some aspects, some or all of the processing units of processing subsystem 1704 can be implemented using customized circuits, such as application specific integrated circuits (ASICs), or field programmable gate arrays (FPGAs).

In some aspects, the processing units in processing subsystem 1704 can execute instructions stored in system memory 1710 or on computer readable storage media 1722. In various aspects, the processing units can execute a variety of programs or code instructions and can maintain multiple concurrently executing programs or processes. At any given time, some or all of the program code to be executed can be resident in system memory 1710 and/or on computer-readable storage media 1722 including potentially on one or more storage devices. Through suitable programming, processing subsystem 1704 can provide various functionalities described above. In instances where computer system 1700 is executing one or more virtual machines, one or more processing units may be allocated to each virtual machine.

In certain aspects, a processing acceleration unit 1706 may optionally be provided for performing customized processing or for off-loading some of the processing performed by processing subsystem 1704 so as to accelerate the overall processing performed by computer system 1700.

I/O subsystem 1708 may include devices and mechanisms for inputting information to computer system 1700 and/or for outputting information from or via computer system 1700. In general, use of the term input device is intended to include all possible types of devices and mechanisms for inputting information to computer system 1700. User interface input devices may include, for example, a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may also include motion sensing and/or gesture recognition devices such as the Meta Quest® controller, Microsoft Kinect® motion sensor, the Microsoft Xbox® 360 game controller, or devices that provide an interface for receiving input using gestures and spoken commands. User interface input devices may also include eye gesture recognition devices such as a blink detector that detects eye activity (e.g., “blinking” while taking pictures and/or making a menu selection) from users and transforms the eye gestures as inputs to an input device. Additionally, user interface input devices may include voice recognition sensing devices that enable users to interact with voice recognition systems (e.g., Siri® navigator or Amazon Alexa®) through voice commands.

Other examples of user interface input devices include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, QR code readers, barcode readers, 3D scanners, 3D printers, laser rangefinders, and eye gaze tracking devices. Additionally, user interface input devices may include, for example, medical imaging input devices such as computed tomography, magnetic resonance imaging, position emission tomography, and medical ultrasonography devices. User interface input devices may also include, for example, audio input devices such as MIDI keyboards, digital musical instruments, and the like.

In general, use of the term output device is intended to include all possible types of devices and mechanisms for outputting information from computer system 1700 to a user or other computer. User interface output devices may include a display subsystem, indicator lights, or non-visual displays such as audio output devices, etc. The display subsystem may be any device for outputting a digital picture. Example display devices include flat panel display devices such as those using a light emitting diode (LED) display, a liquid crystal display (LCD) or plasma display, a projection device, a touch screen, a desktop or laptop computer monitor, and the like. As another example, wearable display devices such as Meta Quest® or Microsoft HoloLens® may be mounted to the user for displaying information. User interface output devices may include, without limitation, a variety of display devices that visually convey text, graphics, and audio/video information such as monitors, printers, speakers, headphones, automotive navigation systems, plotters, voice output devices, and modems.

Storage subsystem 1718 provides a repository or data store for storing information and data that is used by computer system 1700. Storage subsystem 1718 provides a tangible non-transitory computer-readable storage medium for storing the basic programming and data constructs that provide the functionality of some aspects. Storage subsystem 1718 may store software (e.g., programs, code modules, instructions) that when executed by processing subsystem 1704 provides the functionality described above. The software may be executed by one or more processing units of processing subsystem 1704. Storage subsystem 1718 may also provide a repository for storing data used in accordance with the teachings of this disclosure.

Storage subsystem 1718 may include one or more non-transitory memory devices, including volatile and non-volatile memory devices. As shown in FIG. 17, storage subsystem 1718 includes a system memory 1710 and a computer-readable storage media 1722. System memory 1710 may include a number of memories including a volatile main random access memory (RAM) for storage of instructions and data during program execution and a non-volatile read only memory (ROM) or flash memory in which fixed instructions are stored. In some implementations, a basic input/output system (BIOS), containing the basic routines that help to transfer information between elements within computer system 1700, such as during start-up, may typically be stored in the ROM. The RAM typically contains data and/or program modules that are presently being operated and executed by processing subsystem 1704. In some implementations, system memory 1710 may include multiple different types of memory, such as static random access memory (SRAM), dynamic random access memory (DRAM), and the like.

By way of example, and not limitation, as depicted in FIG. 17, system memory 1710 may load application programs 1712 that are being executed, which may include various applications such as Web browsers, mid-tier applications, relational database management systems (RDBMS), etc., program data 1714, and an operating system 1716. By way of example, operating system 1716 may include various versions of Microsoft Windows®, Apple Macintosh®, and/or Linux® operating systems, a variety of commercially-available UNIX® or UNIX-like operating systems (including without limitation the variety of GNU/Linux operating systems, the Oracle Linux®, Google Chrome® OS, and the like) and/or mobile operating systems such as iOS, Windows® Phone, Android® OS, and others.

Computer-readable storage media 1722 may store programming and data constructs that provide the functionality of some aspects. Computer-readable media 1722 may provide storage of computer-readable instructions, data structures, program modules, and other data for computer system 1700. Software (programs, code modules, instructions) that, when executed by processing subsystem 1704 provides the functionality described above, may be stored in storage subsystem 1718. By way of example, computer-readable storage media 1722 may include non-volatile memory such as a hard disk drive, a magnetic disk drive, an optical disk drive such as a CD ROM, digital video disc (DVD), a Blu-Ray® disk, or other optical media. Computer-readable storage media 1722 may include, but is not limited to, Zip® drives, flash memory cards, universal serial bus (USB) flash drives, secure digital (SD) cards, DVD disks, digital video tape, and the like. Computer-readable storage media 1722 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, dynamic random access memory (DRAM)-based SSDs, magnetoresistive RAM (MRAM) SSDs, and hybrid SSDs that use a combination of DRAM and flash memory based SSDs.

In certain aspects, storage subsystem 1718 may also include a computer-readable storage media reader 1720 that can further be connected to computer-readable storage media 1722. Reader 1720 may receive and be configured to read data from a memory device such as a disk, a flash drive, etc.

In certain aspects, computer system 1700 may support virtualization technologies, including but not limited to virtualization of processing and memory resources. For example, computer system 1700 may provide support for executing one or more virtual machines. In certain aspects, computer system 1700 may execute a program such as a hypervisor that facilitated the configuring and managing of the virtual machines. Each virtual machine may be allocated memory, compute (e.g., processors, cores), I/O, and networking resources. Each virtual machine generally runs independently of the other virtual machines. A virtual machine typically runs its own operating system, which may be the same as or different from the operating systems executed by other virtual machines executed by computer system 1700. Accordingly, multiple operating systems may potentially be run concurrently by computer system 1700.

Communications subsystem 1724 provides an interface to other computer systems and networks. Communications subsystem 1724 serves as an interface for receiving data from and transmitting data to other systems from computer system 1700. For example, communications subsystem 1724 may enable computer system 1700 to establish a communication channel to one or more client devices via the Internet for receiving and sending information from and to the client devices. For example, the communications subsystem may be used to transmit a response to a user regarding the inquiry for a chatbot.

Communications subsystem 1724 may support both wired and/or wireless communication protocols. For example, in certain aspects, communications subsystem 1724 may include radio frequency (RF) transceiver components for accessing wireless voice and/or data networks (e.g., using cellular telephone technology, advanced data network technology, such as 3G, 4G or EDGE (enhanced data rates for global evolution), Wi-Fi (IEEE 802.XX family standards, or other mobile communication technologies, or any combination thereof), global positioning system (GPS) receiver components, and/or other components. In some aspects communications subsystem 1724 can provide wired network connectivity (e.g., Ethernet) in addition to or instead of a wireless interface.

Communications subsystem 1724 can receive and transmit data in various forms. For example, in some aspects, in addition to other forms, communications subsystem 1724 may receive input communications in the form of structured and/or unstructured data feeds 1726, event streams 1728, event updates 1730, and the like. For example, communications subsystem 1724 may be configured to receive (or send) data feeds 1726 in real-time from users of social media networks and/or other communication services such as Twitter® feeds, Facebook® updates, web feeds such as Rich Site Summary (RSS) feeds, and/or real-time updates from one or more third party information sources.

In certain aspects, communications subsystem 1724 may be configured to receive data in the form of continuous data streams, which may include event streams 1728 of real-time events and/or event updates 1730, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1724 may also be configured to communicate data from computer system 1700 to other computer systems or networks. The data may be communicated in various different forms such as structured and/or unstructured data feeds 1726, event streams 1728, event updates 1730, and the like to one or more databases that may be in communication with one or more streaming data source computers coupled to computer system 1700.

Computer system 1700 can be one of various types, including a handheld portable device (e.g., an iPhone® cellular phone, an iPad® computing tablet, a personal digital assistant (PDA)), a wearable device (e.g., a Meta Quest® head mounted display), a personal computer, a workstation, a mainframe, a kiosk, a server rack, or any other data processing system. Due to the ever-changing nature of computers and networks, the description of computer system 1700 depicted in FIG. 17 is intended only as a specific example. Many other configurations having more or fewer components than the system depicted in FIG. 17 are possible. Based on the disclosure and teachings provided herein, a person of ordinary skill in the art can appreciate other ways and/or methods to implement the various aspects.

Although specific aspects have been described, various modifications, alterations, alternative constructions, and equivalents are possible. Embodiments are not restricted to operation within certain specific data processing environments, but are free to operate within a plurality of data processing environments. Additionally, although certain aspects have been described using a particular series of transactions and steps, it should be apparent to those skilled in the art that this is not intended to be limiting. Although some flowcharts describe operations as a sequential process, many of the operations can be performed in parallel or concurrently. In addition, the order of the operations may be rearranged. A process may have additional steps not included in the figure. Various features and aspects of the above-described aspects may be used individually or jointly.

Further, while certain aspects have been described using a particular combination of hardware and software, it should be recognized that other combinations of hardware and software are also possible. Certain aspects may be implemented only in hardware, or only in software, or using combinations thereof. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques including but not limited to conventional techniques for inter-process communications, and different pairs of processes may use different techniques, or the same pair of processes may use different techniques at different times.

Specific details are given in this disclosure to provide a thorough understanding of the aspects. However, aspects may be practiced without these specific details. For example, well-known circuits, processes, algorithms, structures, and techniques have been shown without unnecessary detail in order to avoid obscuring the aspects. This description provides example aspects only, and is not intended to limit the scope, applicability, or configuration of other aspects. Rather, the preceding description of the aspects can provide those skilled in the art with an enabling description for implementing various aspects. Various changes may be made in the function and arrangement of elements.

The specification and drawings are, accordingly, to be regarded in an illustrative rather than a restrictive sense. It can, however, be evident that additions, subtractions, deletions, and other modifications and changes may be made thereunto without departing from the broader spirit and scope as set forth in the claims. Thus, although specific aspects have been described, these are not intended to be limiting. Various modifications and equivalents are within the scope of the following claims.

What is claimed is:

1. A computer-implemented method comprising:
causing display of metadata for a current academic pathway of a user, wherein the metadata comprises a measured performance on the current academic pathway, a first progress towards completing the current academic pathway, and a predicted completion date for the current academic pathway;
for each remaining first required unit of academic progress on the current academic pathway, estimating a first cost to obtain the first required unit;
based on one or more first elective units remaining for the current academic pathway, estimating a second cost to obtain the one or more first elective units, wherein the second cost is based at least in part on historical elective units taken for the current academic pathway;
causing display of a plurality of alternative academic pathways, wherein, each alternative academic pathway of the plurality of alternative academic pathways is scored based at least in part on:
determining a second progress towards completing the alternative academic pathway based at least in part on, for each unit of academic progress on the current academic pathway, determining whether the unit counts towards academic progress on the alternative academic pathway;
determining a net cost difference between the current academic pathway and the alternative academic pathway based at least in part on:
for each remaining second required unit of academic progress on the alternative academic pathway, estimating a third cost to obtain the second required unit;
based on one or more second elective units remaining for the alternative academic pathway, estimating a fourth cost to obtain the one or more second elective units, wherein the fourth cost is based at least in part on historical elective units taken for the alternative academic pathway;
determining a difference between aid available for the current academic pathway in comparison to the alternative academic pathway;
receiving a selection of a particular alternative academic pathway;
generating a prompt comprising a particular combination of the second progress towards completing the particular alternative academic pathway, and the net cost difference between the particular alternative academic pathway and the current academic pathway;
prompting a large language model using the prompt to generate one or more reasons for changing academic pathways to the particular alternative academic pathway; and
causing display of the one or more reasons in an editable text window for submission in a process for changing academic pathways to the particular alternative academic pathway.

2. The computer-implemented method of claim 1, further comprising:
determining an interest-based fit between one or more interests stored in association with the user's profile and one or more interests stored in association with the alternative academic pathway; wherein the prompt further includes first information about the one or more interests stored in association with the users profile, second information about the one or more interests stored in association with the particular alternative academic pathway, and third information about one or more interests stored in association with the current academic pathway.

3. The computer-implemented method of claim 1, further comprising: determining a skill-based fit between one or more skills stored in association with the user's profile and one or more skills stored in association with the alternative academic pathway; wherein the prompt further includes first information about the one or more skills stored in association with the users profile, second information about the one or more skills stored in association with the particular alternative academic pathway, and third information about one or more skills stored in association with the current academic pathway.

4. The computer-implemented method of claim 1, further comprising generating a summary of the net cost difference based at least in part on prompting the large language model with another prompt that includes information about the third cost, the fourth cost, and the difference between aid available for the current academic pathway in comparison with the alternative academic pathway; and
causing display of the summary in association with the net cost difference before receiving the selection of the particular alternative academic pathway.

5. The computer-implemented method of claim 1, further comprising:
retrieving first information from a financial aid data source using one or more first authentication parameters;
retrieving second information from an expense data source using one or more second authentication parameters;
including, in the prompt, at least part of the first information and at least part of the second information;
wherein the one or more reasons account for the at least part of the first information and the at least part of the second information.

6. The computer-implemented method of claim 5, wherein the retrieving the first information is performed by a first agent with access to separate tools using separate authentication parameters than a second agent; wherein the retrieving the second information is performed by a second agent with access to separate tools using separate authentication parameters than the first agent.

7. The computer-implemented method of claim 1, further comprising:
retrieving financial information from a first source using one or more first authentication parameters;
retrieving course information from a second data source using one or more second authentication parameters;
including, in the prompt, at least part of the first information and at least part of the second information;
wherein the one or more reasons account for the at least part of the first information and the at least part of the second information.

8. The computer-implemented method of claim 7, wherein the retrieving the first information is performed by a first agent with access to separate tools using separate authentication parameters than a second agent; wherein the retrieving the second information is performed by a second agent with access to separate tools using separate authentication parameters than the first agent.

9. The computer-implemented method of claim 1, further comprising:
retrieving credit information from a first source using one or more first authentication parameters;
retrieving course information from a second data source using one or more second authentication parameters;
including, in the prompt, at least part of the first information and at least part of the second information;
wherein the one or more reasons account for the at least part of the first information and the at least part of the second information.

10. The computer-implemented method of claim 9, wherein the retrieving the first information is performed by a first agent with access to separate tools using separate authentication parameters than a second agent; wherein the retrieving the second information is performed by a second agent with access to separate tools using separate authentication parameters than the first agent.

11. A computer-program product comprising one or more non-transitory machine-readable storage media, including stored instructions configured to cause a computing system to perform a set of actions including:
causing display of metadata for a current academic pathway of a user, wherein the metadata comprises a measured performance on the current academic pathway, a first progress towards completing the current academic pathway, and a predicted completion date for the current academic pathway;
for each remaining first required unit of academic progress on the current academic pathway, estimating a first cost to obtain the first required unit;
based on one or more first elective units remaining for the current academic pathway, estimating a second cost to obtain the one or more first elective units, wherein the second cost is based at least in part on historical elective units taken for the current academic pathway;
causing display of a plurality of alternative academic pathways, wherein, each alternative academic pathway of the plurality of alternative academic pathways is scored based at least in part on:
determining a second progress towards completing the alternative academic pathway based at least in part on, for each unit of academic progress on the current academic pathway, determining whether the unit counts towards academic progress on the alternative academic pathway;
determining a net cost difference between the current academic pathway and the alternative academic pathway based at least in part on:
for each remaining second required unit of academic progress on the alternative academic pathway, estimating a third cost to obtain the second required unit;
based on one or more second elective units remaining for the alternative academic pathway, estimating a fourth cost to obtain the one or more second elective units, wherein the fourth cost is based at least in part on historical elective units taken for the alternative academic pathway;
determining a difference between aid available for the current academic pathway in comparison to the alternative academic pathway;
receiving a selection of a particular alternative academic pathway;
generating a prompt comprising a particular combination of the second progress towards completing the particular alternative academic pathway, and the net cost difference between the particular alternative academic pathway and the current academic pathway;
prompting a large language model using the prompt to generate one or more reasons for changing academic pathways to the particular alternative academic pathway; and
causing display of the one or more reasons in an editable text window for submission in a process for changing academic pathways to the particular alternative academic pathway.

12. The computer-program product of claim 1, wherein the set of actions further includes:
determining an interest-based fit between one or more interests stored in association with the user's profile and one or more interests stored in association with the alternative academic pathway; wherein the prompt further includes first information about the one or more interests stored in association with the users profile, second information about the one or more interests stored in association with the particular alternative academic pathway, and third information about one or more interests stored in association with the current academic pathway.

13. The computer-program product of claim 1, wherein the set of actions further includes: determining a skill-based fit between one or more skills stored in association with the user's profile and one or more skills stored in association with the alternative academic pathway; wherein the prompt further includes first information about the one or more skills stored in association with the users profile, second information about the one or more skills stored in association with the particular alternative academic pathway, and third information about one or more skills stored in association with the current academic pathway.

14. The computer-program product of claim 1, wherein the set of actions further includes generating a summary of the net cost difference based at least in part on prompting the large language model with another prompt that includes information about the third cost, the fourth cost, and the difference between aid available for the current academic pathway in comparison with the alternative academic pathway; and
causing display of the summary in association with the net cost difference before receiving the selection of the particular alternative academic pathway.

15. The computer-program product of claim 1, wherein the set of actions further includes:
retrieving first information from a financial aid data source using one or more first authentication parameters;
retrieving second information from an expense data source using one or more second authentication parameters;
including, in the prompt, at least part of the first information and at least part of the second information;
wherein the one or more reasons account for the at least part of the first information and the at least part of the second information; wherein the retrieving the first information is performed by a first agent with access to separate tools using separate authentication parameters than a second agent; wherein the retrieving the second information is performed by a second agent with access to separate tools using separate authentication parameters than the first agent.

16. A system comprising:
one or more processors;
one or more non-transitory computer-readable media storing instructions, which, when executed by the system, cause the system to perform a set of actions including:
causing display of metadata for a current academic pathway of a user, wherein the metadata comprises a measured performance on the current academic pathway, a first progress towards completing the current academic pathway, and a predicted completion date for the current academic pathway;
for each remaining first required unit of academic progress on the current academic pathway, estimating a first cost to obtain the first required unit;
based on one or more first elective units remaining for the current academic pathway, estimating a second cost to obtain the one or more first elective units, wherein the second cost is based at least in part on historical elective units taken for the current academic pathway;
causing display of a plurality of alternative academic pathways, wherein, each alternative academic pathway of the plurality of alternative academic pathways is scored based at least in part on:
determining a second progress towards completing the alternative academic pathway based at least in part on, for each unit of academic progress on the current academic pathway, determining whether the unit counts towards academic progress on the alternative academic pathway;
determining a net cost difference between the current academic pathway and the alternative academic pathway based at least in part on:
for each remaining second required unit of academic progress on the alternative academic pathway, estimating a third cost to obtain the second required unit;
based on one or more second elective units remaining for the alternative academic pathway, estimating a fourth cost to obtain the one or more second elective units, wherein the fourth cost is based at least in part on historical elective units taken for the alternative academic pathway;
determining a difference between aid available for the current academic pathway in comparison to the alternative academic pathway;
receiving a selection of a particular alternative academic pathway;
generating a prompt comprising a particular combination of the second progress towards completing the particular alternative academic pathway, and the net cost difference between the particular alternative academic pathway and the current academic pathway;
prompting a large language model using the prompt to generate one or more reasons for changing academic pathways to the particular alternative academic pathway; and
causing display of the one or more reasons in an editable text window for submission in a process for changing academic pathways to the particular alternative academic pathway.

17. The system of claim 1, wherein the set of actions further includes:
determining an interest-based fit between one or more interests stored in association with the user's profile and one or more interests stored in association with the alternative academic pathway; wherein the prompt further includes first information about the one or more interests stored in association with the users profile, second information about the one or more interests stored in association with the particular alternative academic pathway, and third information about one or more interests stored in association with the current academic pathway.

18. The system of claim 1, wherein the set of actions further includes: determining a skill-based fit between one or more skills stored in association with the user's profile and one or more skills stored in association with the alternative academic pathway; wherein the prompt further includes first information about the one or more skills stored in association with the users profile, second information about the one or more skills stored in association with the particular alternative academic pathway, and third information about one or more skills stored in association with the current academic pathway.

19. The system of claim 1, wherein the set of actions further includes generating a summary of the net cost difference based at least in part on prompting the large language model with another prompt that includes information about the third cost, the fourth cost, and the difference between aid available for the current academic pathway in comparison with the alternative academic pathway; and
causing display of the summary in association with the net cost difference before receiving the selection of the particular alternative academic pathway.

20. The system of claim 1, wherein the set of actions further includes:
retrieving first information from a financial aid data source using one or more first authentication parameters;
retrieving second information from an expense data source using one or more second authentication parameters;
including, in the prompt, at least part of the first information and at least part of the second information;
wherein the one or more reasons account for the at least part of the first information and the at least part of the second information; wherein the retrieving the first information is performed by a first agent with access to separate tools using separate authentication parameters than a second agent; wherein the retrieving the second information is performed by a second agent with access to separate tools using separate authentication parameters than the first agent.
